(19) United States
(12) Patent Application Publication
(10) Pub. No.: US 2012/0089540 A1
(43) Pub. Date: Apr. 12, 2012

(54) Cart systems and methods for delivering pharmaceutical items to a retail seller

(76) Inventors: Mike MANIVILOVSKI, Lewis Center, OH (US); William James Taylor, Sunbury, OH (US)

(21) Appl. No.: 12/902,422

(22) Filed: Oct. 12, 2010

(51) Int. Cl. A47B 81/00; E05B 65/44; G09F 3/00; G06Q 90/00

(52) U.S. Cl. 705/500; 312/209; 70/78; 40/312

(57) ABSTRACT

A cart system for distributing pharmaceutical items includes a cart and a plurality of totes. The cart has a wheeled base, framework, a door, and a locking mechanism. The framework extends upwardly from the base and forms an interior storage region having a front, a rear, and opposing sides. An access opening at the front is provided, with the door movable to a closed position that partially blocks the access opening. The locking mechanism selectively locks the door in the closed position. In a shipping state, the totes are loaded within the storage region and the door locked. The totes are visible from an exterior of the cart, but cannot be removed without evidence of tampering. The framework can divide the storage region into two or more columns, and includes platforms within the columns and arranged to define compartments sized to receive respective ones of the totes.

### BACKGROUND

The present disclosure relates to systems and methods for distributing pharmaceuticals. More particularly, it relates to cart-based systems and methods for preparing and shipping an inventory of different, packaged pharmaceutical items (e.g., prescription and non-prescription medications or drugs) from a primary distributor to a secondary seller of the items, such as retailer pharmacies and mail order pharmacies.

Primary distributors or distribution centers commonly facilitate distribution of pharmaceutical items from a manufacturer to a secondary seller (or “retail seller”). By way of background, a typical pharmaceutical distribution methodology entails the primary distributor warehousing significant quantities of a large number of different, packaged medications or other pharmaceutical items made by various manufacturers. Retail sellers will ultimately sell at least some of these items to patients, and thus desire to have a small amount of various pharmaceutical items on-hand (or in stock) at all times. It will be understood that due to the number of pharmaceutical manufacturers and the relatively small quantities needed by a retail seller at any point in time render it highly impractical for the retail seller to order directly from a manufacturer. Thus, the retail seller periodically orders various quantities of some of the packaged pharmaceutical items offered by the primary distributor in volumes commensurate with actual or expected sales. In this regard, retail sellers commonly maintain their in-house stock or small inventory of packaged pharmaceutical items in an on-site shelving system, consistently storing each of the particular medication/formats on the shelves in a designated, retail seller-specific order.

While retail sellers may sell more of some medications as compared to others, pharmaceutical item orders placed with the primary distributor essentially always include a number of different pharmaceutical types, as well as different formats (e.g., a single order from a retail seller to a primary distributor can include twenty packages of medication product A in 100 mg tablet form, forty packages of medication product A in 500 mg capsule form, thirty packages of medication product B, twenty-five packages of medication product C, etc.). As a point of reference, certain retail sellers (e.g., mail order pharmacies) may fill in upwards of 20,000 prescriptions per day, and thus will order significant quantities from the primary distributor. Regardless, upon receiving an order, employees of the primary distributor “fill” the order by preparing one or more boxes or “totes” with requested quantities of each pharmaceutical item/format. The totes are typically of a standard size and can hold a fairly large number of individual, packaged pharmaceutical items. For many retail sellers, however, a single tote is not large enough to hold all ordered products. Under these circumstances, the primary distributor will prepare or fill a series of totes to meet the retail seller's order. Some of the totes may contain only a single type of medication; others will contain a plurality of different pharmaceutical items/formats. Conventionally, the pharmaceutical items are not sorted within a particular tote; instead, multiple different products are randomly mixed together within the tote. The filled totes are banded to a skid and then shipped to the retail seller.

Upon receiving a shipment from the primary distributor, the retail seller's employees must remove and un-band the totes from the skid, open each tote to confirm content, and then remove all packaged pharmaceuticals from the totes. Where different products are randomly mixed within a tote, confirming the content of a particular delivery can be very time consuming. The removed packaged products are then placed on an open, wheeled cart in a somewhat ordered fashion. The retail seller's employee may attempt to load the individual, packaged pharmaceutical items onto the open cart in a manner generally corresponding with the order of products along the retail seller's shelving system. From this point the retail seller's employee wheels the cart along the designated line of shelves, removing pharmaceutical items from the cart and placing them at appropriate locations along the shelving system. This too can be a very time consuming task as the items are often randomly arranged on the cart, requiring the worker to repeatedly move back-and-forth between the shelves.

While well-accepted, the current methodologies for distributing pharmaceutical items from a primary distributor to a retail seller (especially a high volume retail seller, such as a mail order pharmacy) necessitate that the packaged pharmaceuticals be handled several times, and require that the retail seller perform a number of processing steps; the retail seller employees spend a great deal of time on non-value added steps. Further, the time required for the retail seller's employees to unload the shipped pallet and then re-load individual carts may lead to undesirable stock out issues. Further, the emptied totes are accumulated at the retail seller's site, and must be returned to the primary distributor. In the context of high volume mail order pharmacies, mail order pharmacy retail sellers usually receive thousands of pharmaceutical products each day, in hundreds of unorganized plastic bins. The mail order pharmacy retail seller must allocate significant staff time to unload the hundreds of palletized totes from delivery trucks, then unpack, sort, and scan thousands of individual products before putting them away in the designated areas of their facility. In addition, security concerns may arise when shipping the loaded totes from the primary distributor to the retail seller.

In light of the above, a need exists for improved systems and methods for delivering or distributing pharmaceutical items from a primary distributor to a secondary seller of pharmaceuticals.

### SUMMARY

Some aspects in accordance with principles of the present disclosure relate to a cart system for controlled distribution of pharmaceutical items from a primary distributor to a secondary seller of pharmaceuticals. The cart system includes a cart and a plurality of totes. The cart includes a base, wheels, framework, a door, and a locking mechanism. The wheels are connected to an underside of the base. The framework extends upwardly from the base and forms an interior storage region having a front, a rear, and opposing sides. In this regard, the framework defines an access opening to the front of the interior storage region through which the totes are inserted or removed. The door is movable relative to the framework between open and closed positions. In the closed position, the door extends over and blocks a portion of the access opening. In the open position, the door is displaced from the access opening. Finally, the locking mechanism selectively locks the door in the closed position. In a shipping state of the cart system, the totes are loaded with various pharmaceutical items and placed within the interior storage region, and the door locked in the closed position by the locking mechanism. The totes are visible from an exterior of the cart in the shipping state, but cannot be removed from the interior storage region without evidence of tampering. In some embodiments, the framework includes a series of vertical uprights dividing the interior storage region into two or more columns, along with platforms arranged within each of the columns to define compartments sized to receive respective ones of the totes. In related embodiments, the door includes one or more rails arranged such that in the closed position, the rails block one or more of the columns. In other embodiments, the totes include a bin and two container assemblies each consisting of a container and one or more removable dividers. The container assemblies are arranged side-by-side within the bin. The divider(s) is removably arranged at a desired location within the container to define containment zones sized in accordance with selected pharmaceutical items.

Yet other aspects in accordance with principles of the present disclosure relate to a system for controlled distribution of pharmaceutical items from a primary distributor to first and second secondary sellers of pharmaceuticals. The system includes first and second cart systems. Each of the cart systems includes a wheeled base, a door assembly, a plurality of totes, and a plurality of pharmaceutical items. The wheeled base maintains framework forming an interior storage region divided into at least three columns each having a width and a length. The door assembly is pivotably coupled to the framework for selectively blocking an access opening to each of the columns. The plurality of totes are stored within respective ones of the columns. Each of the totes has a length greater than a width, the totes, length being slightly less than the column length and the tote width being slightly less than the column width. The plurality of pharmaceutical items are contained within respective ones of the totes, with at least one of the pharmaceutical items in a first one of the totes differing in format from pharmaceutical items in an other of the totes. The cart systems are arranged in a shipping state in which the door assembly is locked in a closed position relative to the corresponding framework to prevent removal of the corresponding totes. Further, the pharmaceutical items of the first cart system are pre-selected for a first secondary seller, and the pharmaceutical items of the second cart system are pre-selected from a second secondary seller, with the first cart system pharmaceutical items differing from the second cart system pharmaceutical items.

Yet other aspects in accordance with principles of the present disclosure relate to a method for distributing pharmaceutical items from a primary distributor to a secondary seller of pharmaceuticals. The method includes maintaining an inventory of pharmaceutical items at the primary distributor. A request from a secondary seller for a plurality of different pharmaceutical items is received by the primary distributor. A first set of the requested pharmaceutical items is retrieved from the inventory of the primary distributor and placed into a first tote. A second set of the requested pharmaceutical items is also retrieved and placed into a second tote. The first and second totes are loaded into a cart including a base, wheels, framework, and a door. The wheels are connected to an underside of the base, with the framework extending upwardly from the base. The framework forms an interior storage region having a front, a rear, opposing sides. An access opening for loading/unloading the totes at the front of the interior storage region is defined by the framework. The door is coupled to the framework to provide a closed position and an open position. In the closed position, the door extends over the access opening. In the open position, the door is displaced from the access opening. Loading of the first and second totes into the cart includes disposing the first and second totes within the interior storage region. The door is locked relative to the framework to form a cart system in a shipping state. In this shipping state, the first and second totes are secured within, but exteriorly visible through, the framework and the door. The cart system, in the shipping state, is then delivered to the secondary seller. In some embodiments, the tote includes a first container assembly consisting of a container and a divider, and the first set of requested pharmaceutical items includes pharmaceutical items having differing first and second formats. With this in mind, the step of placing the first set of pharmaceutical items within the first tote includes sorting the items within the tote such as by loading the first format pharmaceutical items into a first zone of the container. The divider is assembled within the container to define a second zone discrete from the first zone. The second format pharmaceutical items are then loaded into the second zone.

### BRIEF DESCRIPTION OF THE DRAWINGS

FIG. 1 is a block diagram of a distribution system incorporating cart systems in accordance with principles of the present disclosure;

FIG. 2A is a perspective view of a cart system in accordance with principles of the present disclosure and in a shipping state;

FIG. 2B is a perspective view of the cart system of FIG. 2A in a load/unload state;

FIG. 3A is a top view of a portion of a cart useful with the cart system of

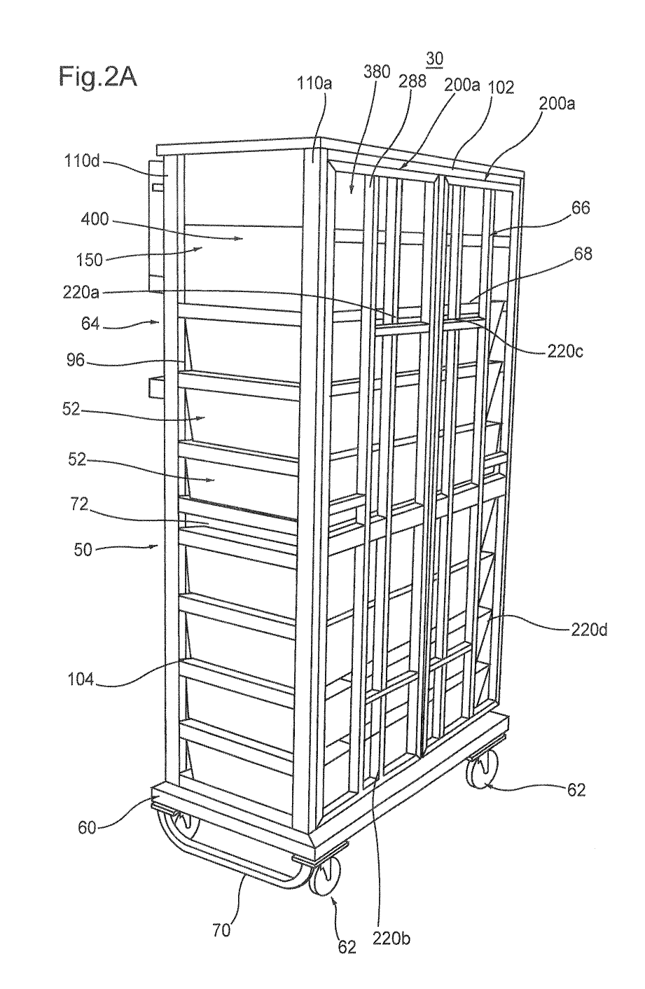

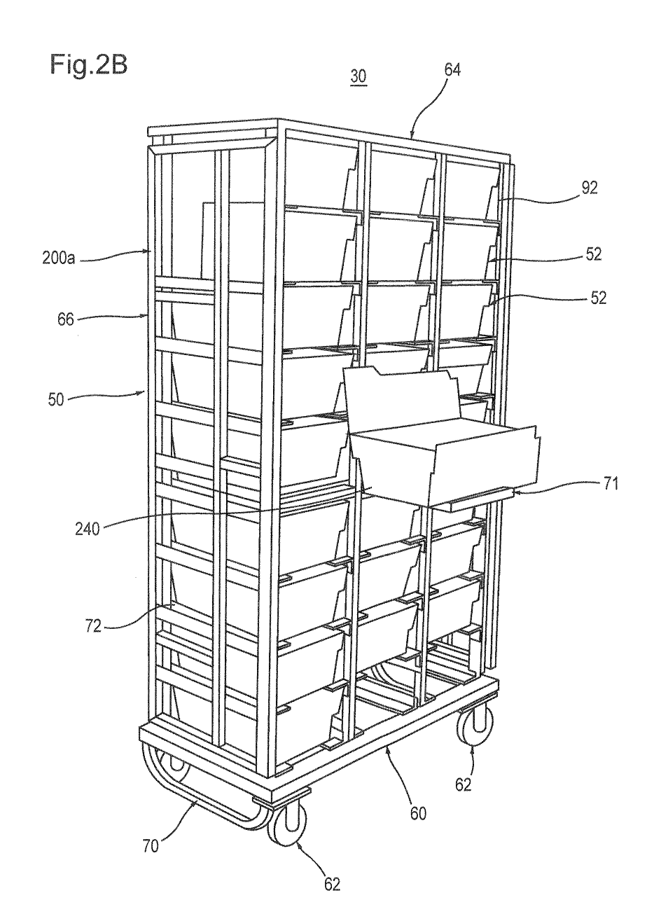

FIG. 2A, with door components portions removed;

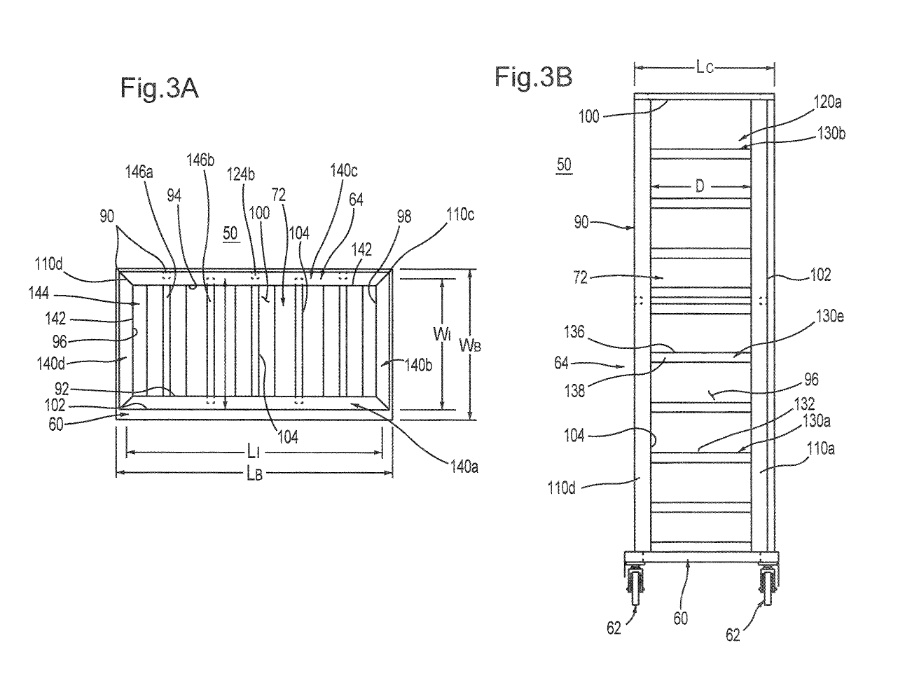

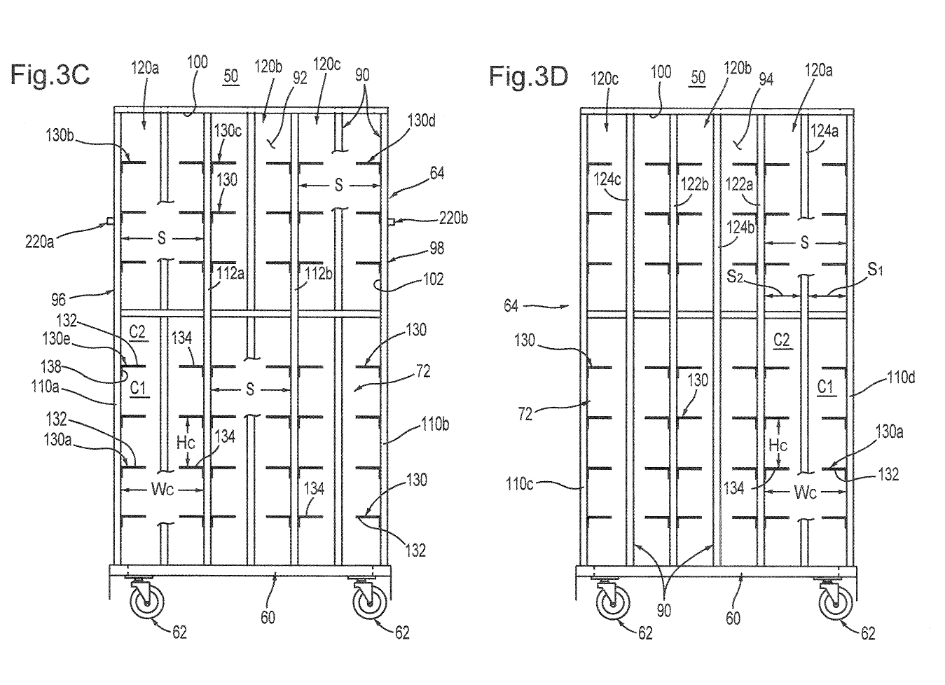

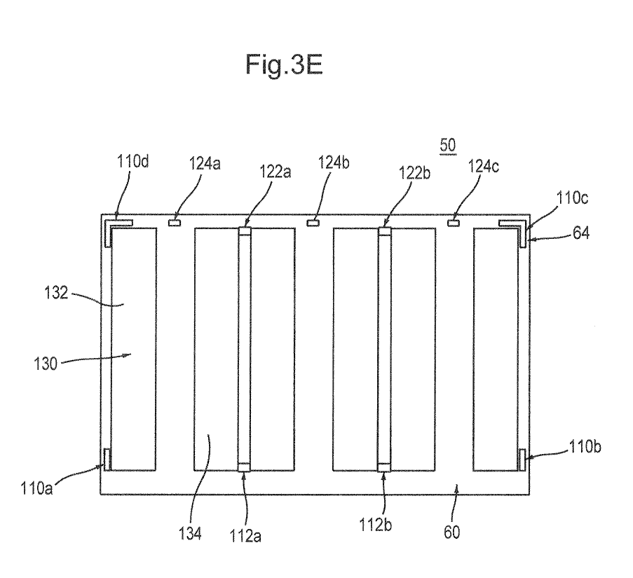

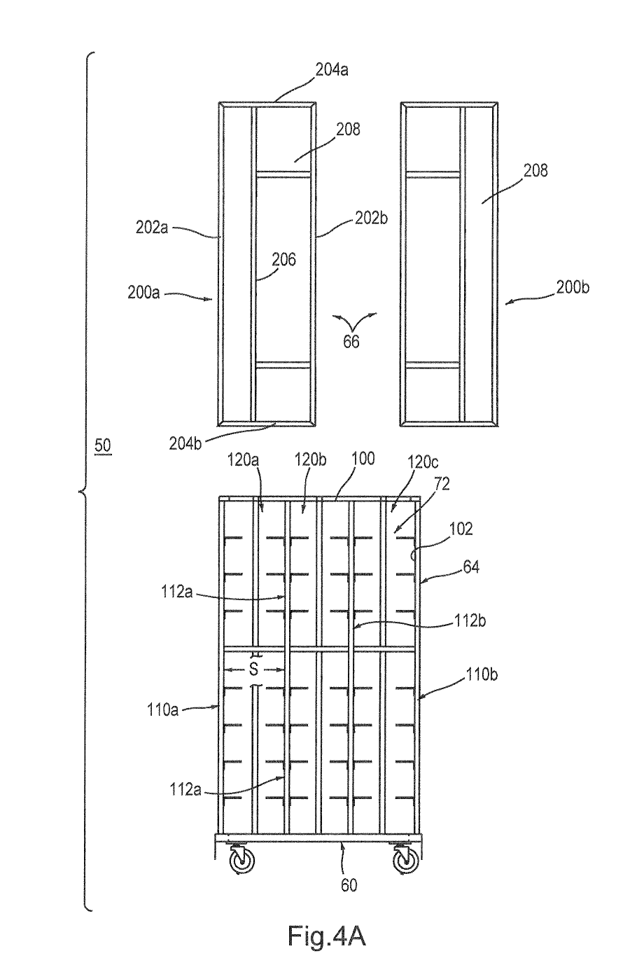

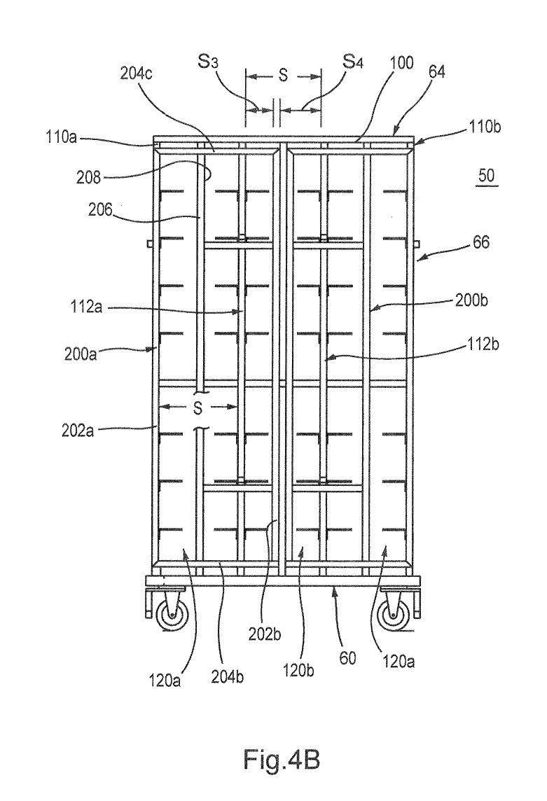

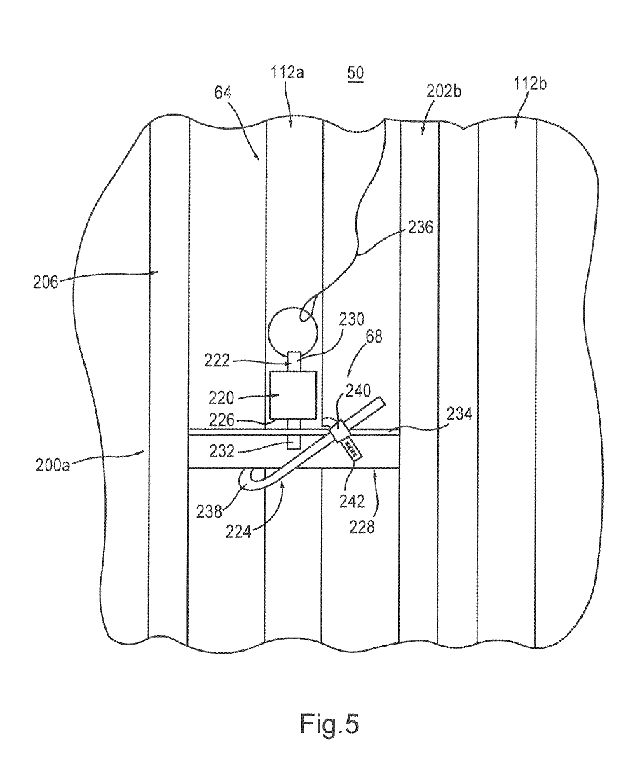

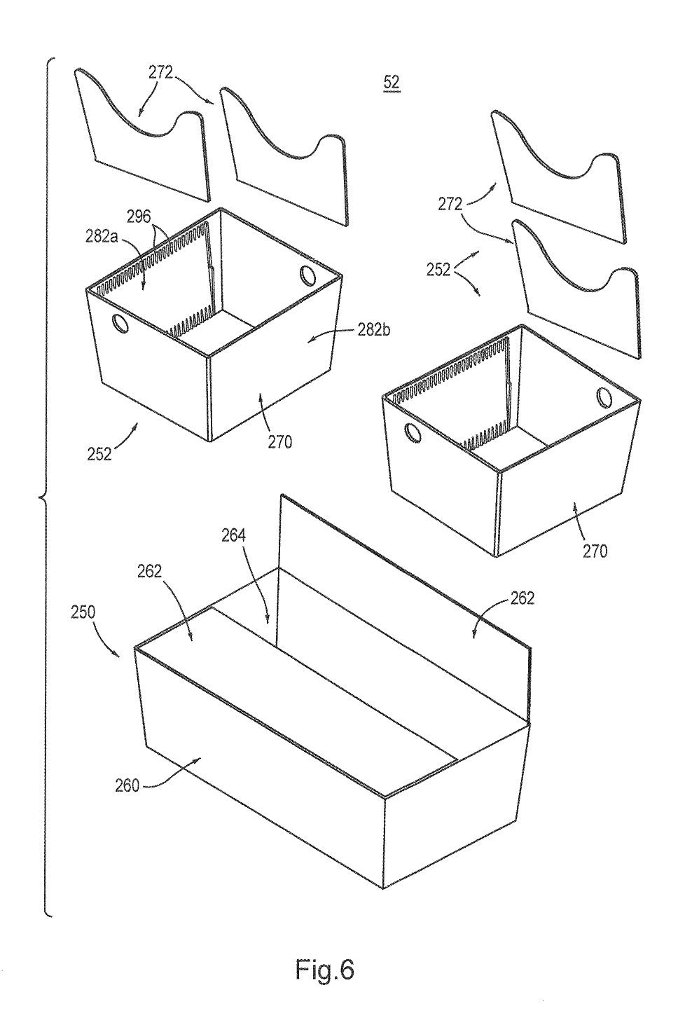

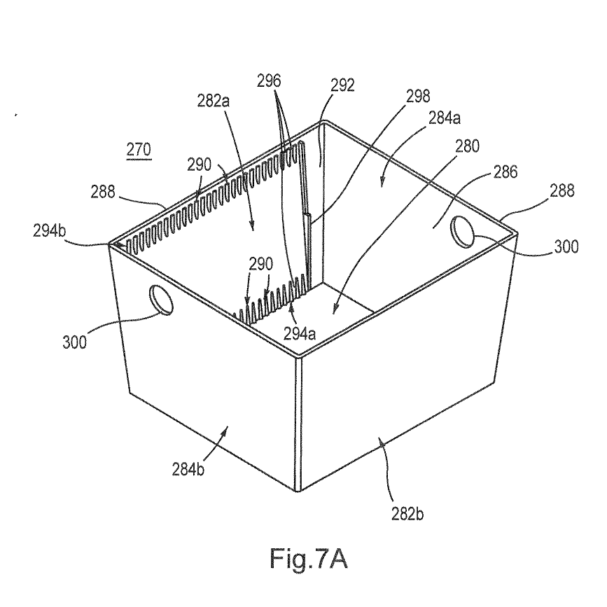

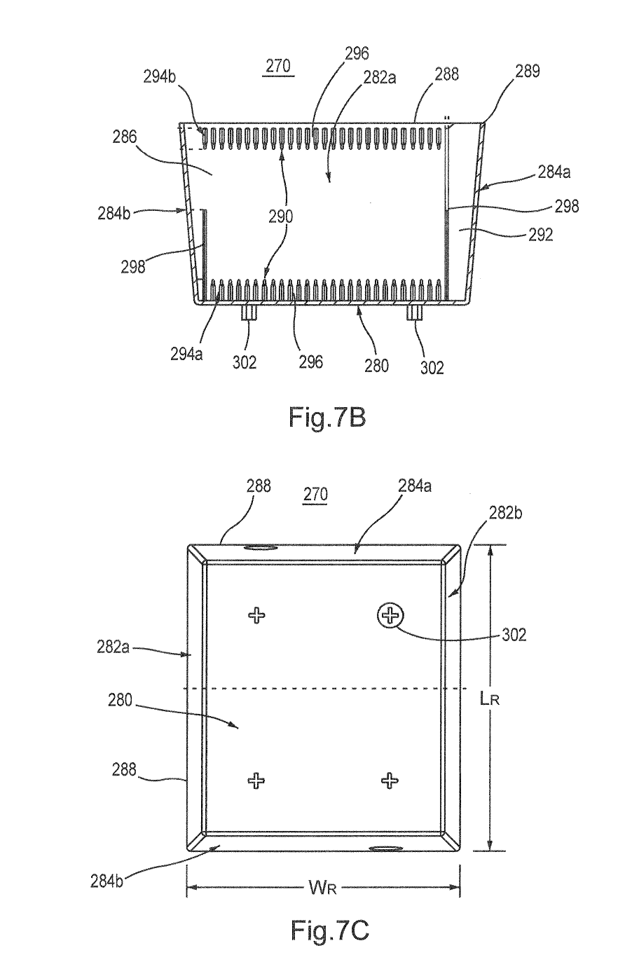

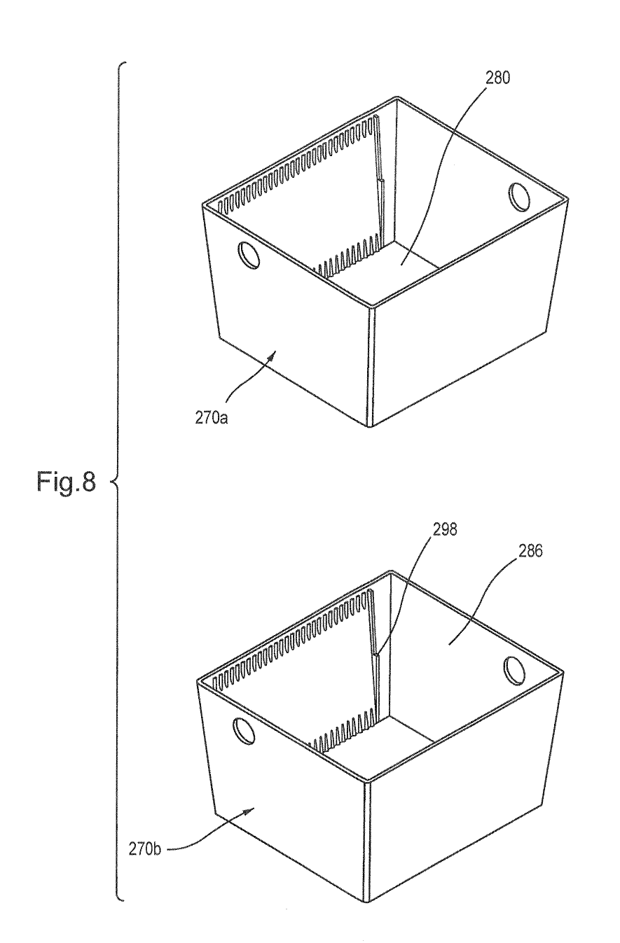

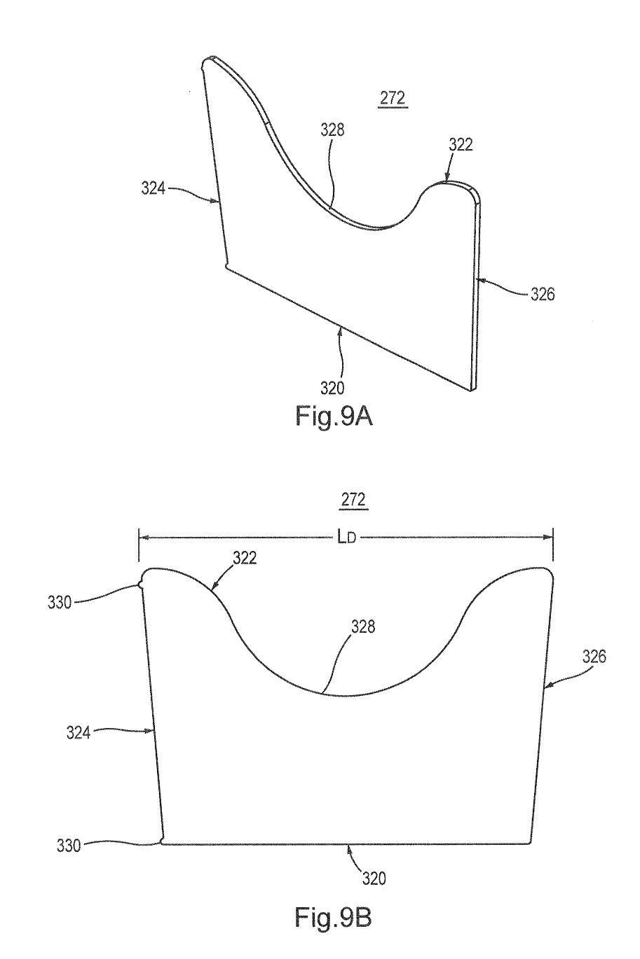

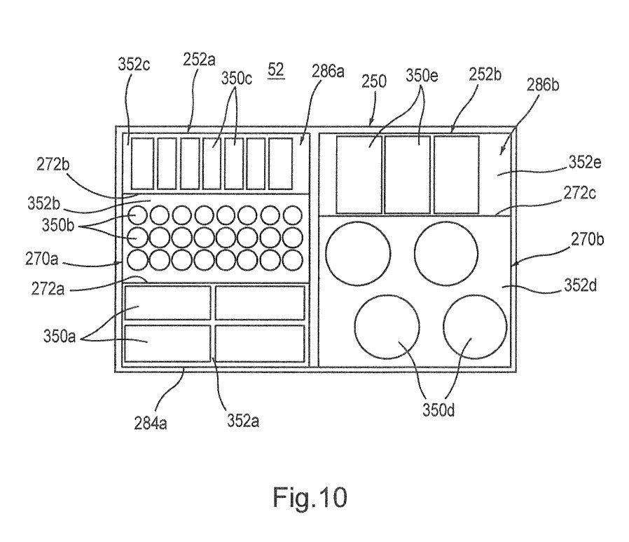

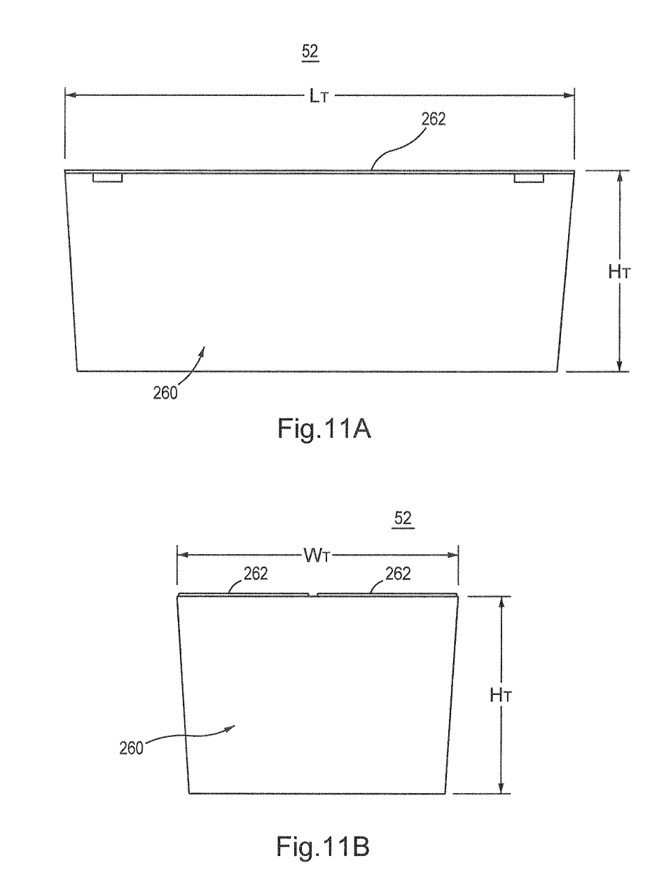

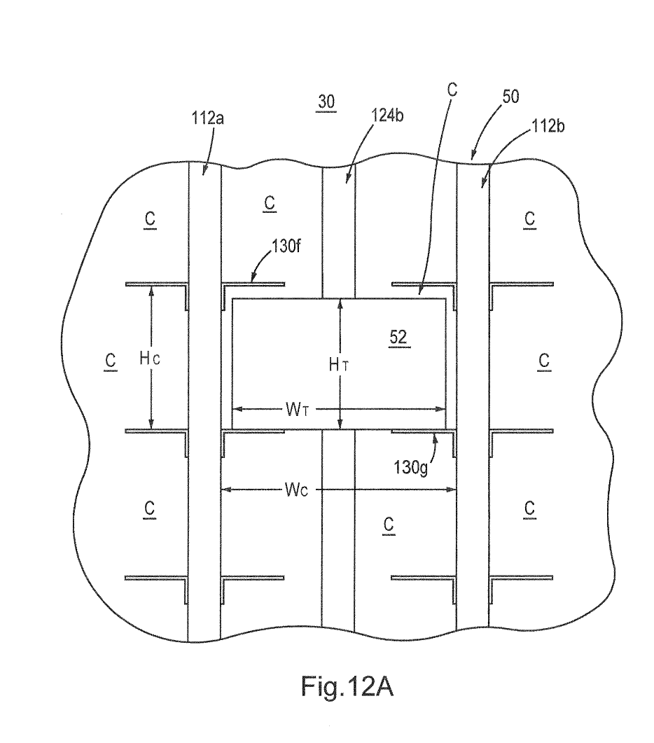

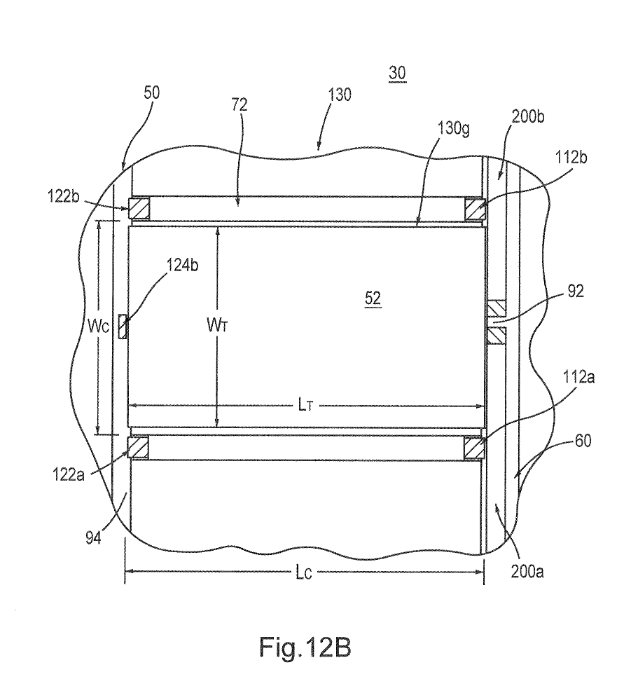

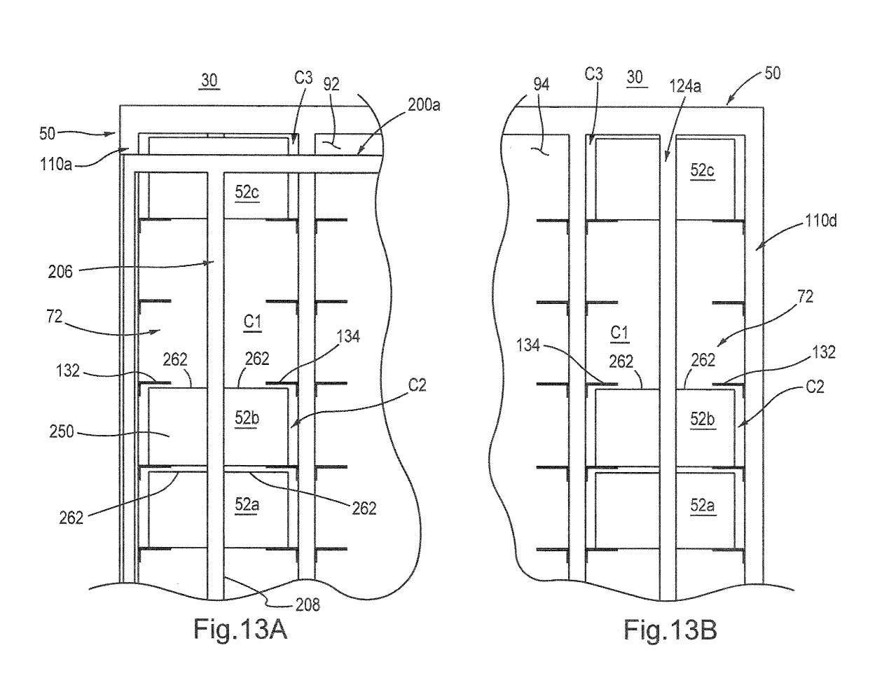

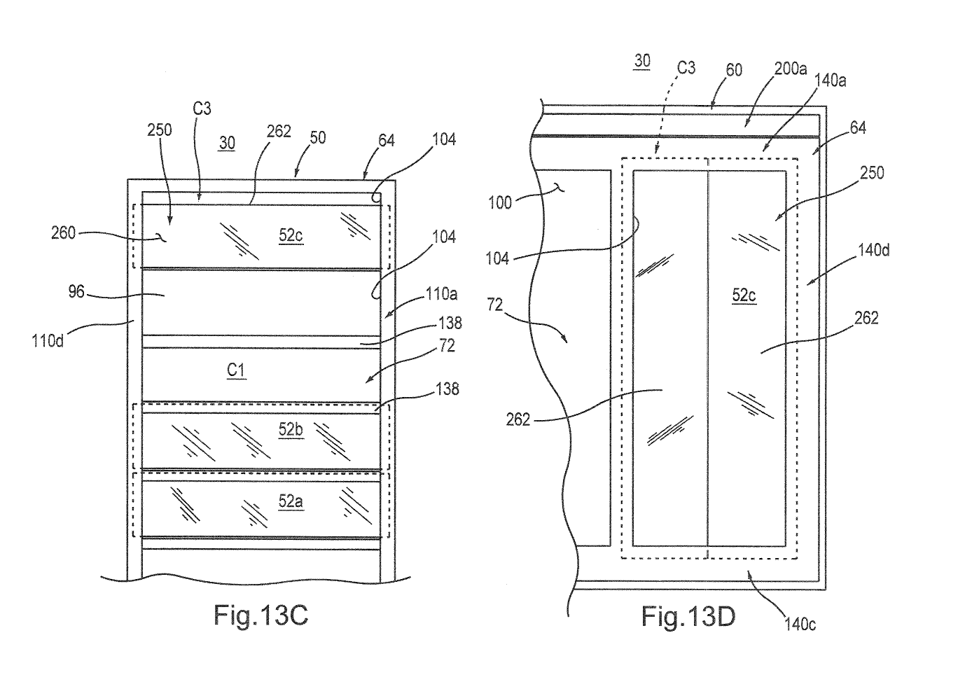

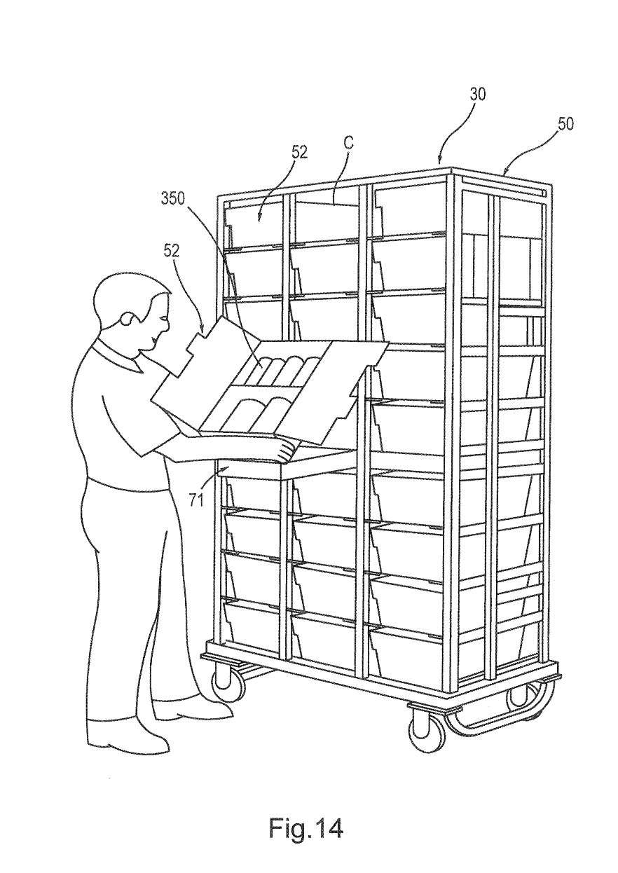

FIG. 3B is a side view of the cart of FIG. 3A;

FIG. 3C is a front view of the cart of FIG. 3A;

FIG. 3D is a rear view of the cart of FIG. 3A;

FIG. 3E is a top view of the cart of FIG. 3A with framework components removed;

FIG. 4A is an exploded view of the cart useful with the cart system of FIG. 2A, and illustrating door components;

FIG. 4B is a front view of the cart of FIG. 4A;

FIG. 5 is an enlarged, simplified front view of a portion of the cart of FIG. 2A, illustrating a locking mechanism;

FIG. 6 is an exploded view of a tote useful with the cart system of FIG. 2A;

FIG. 7A is a perspective view of a container component of the tote of FIG. 6;

FIG. 7B is a cross-sectional view of the container of FIG. 7A;

FIG. 7C is a bottom view of the container of FIG. 7A;

FIG. 8 is an exploded view illustrating stacking of two of the containers of FIG. 7A;

FIG. 9A is a perspective view of a divider component of the tote of FIG. 6;

FIG. 9B is a front view of the divider of FIG. 9A;

FIG. 10 is a simplified top view of the tote of FIG. 6 loaded with pharmaceutical items;

FIG. 11A is a side view of the tote of FIG. 6;

FIG. 11B is an end view of the tote of FIG. 11A;

FIG. 12A is an enlarged, simplified front view of the cart system of FIG. 2A with portions removed and illustrating a dimensional relationship between one of the totes of FIG. 6 relative to compartments defined by the cart;

FIG. 12B is a simplified top view of the arrangement of FIG. 12A;

FIG. 13A is a simplified front view of the cart system of FIG. 2A illustrating three of the totes loaded within the cart;

FIG. 13B is a rear view of the arrangement of FIG. 13A;

FIG. 13C is a side view of the arrangement of FIG. 13A;

FIG. 13D is a top view of the arrangement of FIG. 13A; and

FIG. 14 is a perspective view of the cart system of FIG. 2B in the load/unload state and being unloaded by a user.

### DETAILED DESCRIPTION

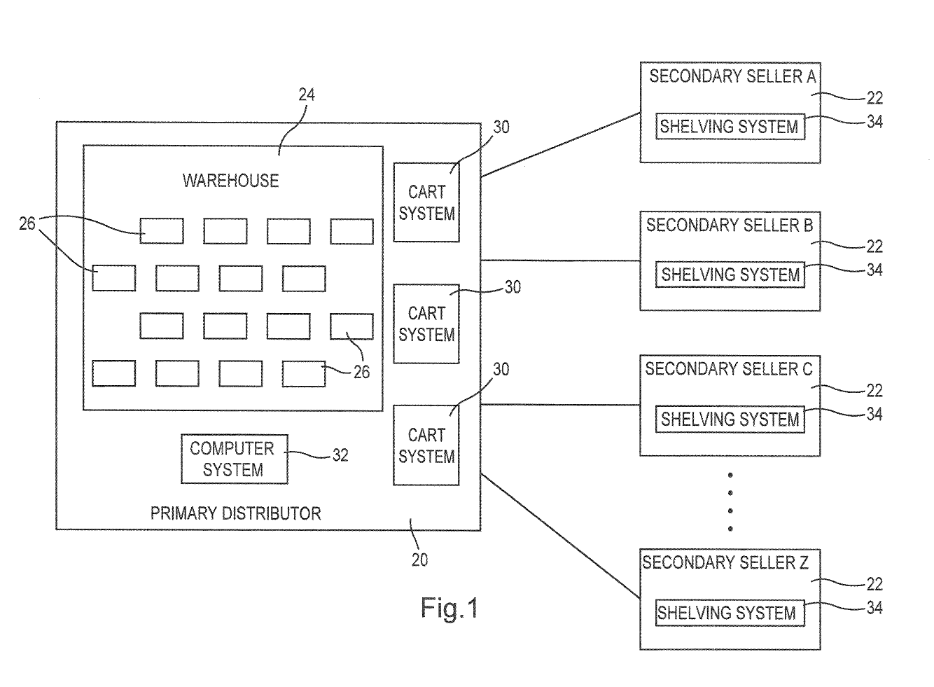

Aspects of the present disclosure relate to systems and methods for distributing pharmaceutical items from a primary distributor 20 to one or more secondary sellers 22 as generally reflected by the block diagram of FIG. 1. The primary distributor 20 (for example a pharmaceutical distribution center) operates one or more warehouses 24 at which a large inventory of a plurality of different pharmaceutical items 26 (referenced generally) are maintained. To facilitate distribution of desired quantities of the pharmaceutical items 26 to the secondary sellers 22, the present disclosure provides one or more mobile cart systems 30. The cart systems 30 are described in greater detail below. As a point of reference, however, in response to a request or order for pharmaceutical items from one of the secondary sellers 22, the primary distributor 20 loads one or more of the cart systems 30 with requested quantities of the pharmaceutical item(s) 26 for delivery to the secondary seller 22. The secondary seller 22 then unloads the so-supplied cart systems 30 directly onto its shelving system. In some embodiments, distribution systems and methods of the present disclosure further include an optional computer system 32 that is programmed to generate an optional plan for loading of the cart systems 30 in a predetermined manner based upon known information relating to a shelving system 34 utilized at or by the secondary seller 22 being served.

One embodiment of the cart system 30 in accordance with the present disclosure is shown in FIGS. 2A and 2B, and includes a cart 50 and a plurality of totes 52. Details on the various components are provided below. In general terms, however, the totes 52 are loaded with a variety of different pharmaceutical items (not shown), and are selectively maintained or stored within the cart 50. The cart 50 can be arranged to a shipping state (FIG. 2A) in which the totes 52 (and contained pharmaceutical items) cannot be removed from the cart 50 without evidence of tampering (e.g., via numbered zip tie-type seals described below). One or more identifiers (described below) of the pharmaceutical items stored within the cart system 30 is provided on the cart 50 (and/or on the totes 52), and the totes 52 may be partially visible through the cart 50 in the shipping state. Optionally, individual ones of the totes 52 can be loaded with designated pharmaceutical items and arranged within the cart 50 in a designated manner generally corresponding with a retail seller's shelving system. Regardless, the cart system 30 can be fully prepared by the primary distributor 22 (FIG. 1) and then shipped to the designated secondary seller 24 (FIG. 1) in the shipping state. Upon receipt, the secondary seller 24 simply transitions the cart 50 to a load/unload state (FIG. 2B), and removes individual ones of the totes 52 and the pharmaceutical items contained therein for placement on the secondary seller's shelving system.

The cart 50 includes a base 60, wheels 62, framework 64, a door assembly 66 (referenced generally), and a locking mechanism 68 (referenced generally in FIG. 2A). The cart 50 can include other components, such as optional wheel guards 70 and/or a retractable table 71 (FIG. 2B). The base 60 supports the framework 64 relative to the wheels 62, with the framework 64 establishing an internal storage region 72 (referenced generally). The door assembly 66 is movably connected to the framework 64, transitionable between a closed position (reflected in FIG. 2A) in which the door assembly 66 partially blocks access to the interior storage region 72, and an open position (FIG. 2B) in which the interior storage region 72 (and in particular the totes 52 stored therein) is freely accessed. The locking mechanism 68 selectively locks the door assembly 66 in the closed position in a tamper evident manner; further, the locking mechanism 68 can be employed to hold the door assembly 66 in the open position. The optional wheel guards 70 protect a user's feet from inadvertent contact with the wheels 62, and the optional table 71 provides a surface for temporarily supporting one of the totes 52 during unloading.

FIGS. 3A-3D provide various views of the cart 50 with the totes 52 removed;

further, the door assembly 66 is omitted from the views of FIGS. 3A-3D to better illustrate features of the framework 64. The base 60 defines a bottom of the interior storage region 72, and can be a solid, continuous body. In that the framework 64 and the loaded totes 52 (FIG. 2A) can be relatively heavy, the base 60 is formed of a structurally robust material, such as steel. Regardless, the base 60 generally defines a maximum horizontal footprint of the cart 50, including a length L_{B} and a width W_{B} as identified in FIG. 3A (top view of the cart 50). In some constructions, the length L_{B} and the width W_{B} of the base 60 are selected as a function of a desired length L_{I} and width W_{I} of the interior storage region 72 in the horizontal plane, with these interior storage region dimensions being selected in accordance with known dimensions (e.g., length and width) of the totes 52 (it being understood that due to a thickness of various components of the framework 64, to the extent the framework 64 is entirely supported by the base 60, the length L_{I} and width W_{I} of the interior storage region 72 are inherently less than the corresponding length L_{B} and width W_{B} of the base 60). The totes 52 can have a predetermined size in the horizontal plane; based upon this known size, desired length L_{I} and width W_{I} dimensions of the interior storage region 72 can be determined, and from this determination (and a thickness of various framework 64 components), the length L_{B} and width W_{B} of the base 60 selected. For example, the length L_{B} and the width W_{B} of the base 60 can be selected such that the interior storage region 72 is sized to contain three of the totes 52 arranged side-by-side across the interior storage region length L_{I}. In some embodiments, the length L_{B} of the base 60 is in the range of 35-55 inches, alternatively approximately 42 inches; the width W_{B} of the base 60 is in the range of 19-26 inches, alternatively approximately 23 inches. Other dimensions are also envisioned. Further, the base 60 can have shapes other than rectangular, such as square, circular, oval, etc.

The wheels 62 are assembled to an underside 74 of the base 60, and can assume various forms. For example, the wheels 62 can be provided as part of roto-caster wheel-type assemblies. In other embodiments, one or more of the wheels 62 are connected to the base 60 in a manner that prevents pivoting of the wheel 62 relative to the base 60. Regardless, four of the wheels 62 are typically provided, arranged at or adjacent corners of the base 60. In other embodiments, five or more of the wheels 62 can be included; conversely, the cart 50 can include three or less of the wheels 62.

The framework 64 extends upwardly from the base 60 and includes a plurality of vertical uprights 90 (referenced generally) that combine to define a front 92, a rear 94, a first side 96, an opposing second side 98, and a top 100 of the interior storage region 72. Further, the framework 64 defines an access opening 102 to the interior storage region 72 at the front 92 through which the totes 52 (FIG. 2A) can pass. While the framework 64 may generate various secondary openings 104 (referenced generally, for example in FIG. 3B) into the internal storage 72 at the rear 94, sides 96, 98, and/or the top 100, the secondary openings 104 are smaller in size than corresponding dimensions of the totes 52 such that the totes 52 cannot pass through the secondary openings 104 as described below.

The uprights 90 are metal rails or beams, and include first-fourth corner uprights 110a-110d. Relative to the front 92 of the interior storage region 72, the first and second corner uprights 110a, 110b can be viewed as “front” corner uprights, and the third and fourth corner uprights 110c, 110d can be viewed as “rear” corner uprights. The corner uprights 110a-110d are each assembled to, and project upwardly (vertically) from, the base 60 at a location adjacent a respective corner of the base 60. The front or first and second corner uprights 110a, 110b are optionally slightly offset from the corresponding leading side of the base 60 to accommodate a thickness of the door assembly 66 (FIG. 2A). Regardless, the corner uprights 110 define a length and width (in the horizontal plane) of the framework 64.

As best shown in FIG. 3C, the uprights 90 further include one or more front intermediate uprights 112 at or adjacent the front 92 of the interior storage region 72. The front intermediate uprights 112 are aligned with, but laterally spaced from, the front corner uprights 110a, 110b. With the embodiment of FIG. 3C, the framework 64 includes first and second front intermediate uprights 112a, 112b, although a greater or lesser number is also acceptable. A lateral spacing S is established between the first corner upright 110a and the first front intermediate upright 112a, between the first and second front intermediate uprights 112a, 112b, and between the second front intermediate upright 112b and the second corner upright 110b. The lateral spacing S between the respective pairs of uprights 110a/112a, 112a/112b, 112b/110b may or may not be identical. Regardless, the lateral spacing S is selected in accordance with corresponding dimension(s) of the totes 52 (FIG. 2A) and is generally sized to permit passage of ones of the totes 52 into and out of the interior storage region 72 via the access opening 102. Effectively, then, the front intermediate uprights 112a, 112b and the first and second corner uprights 110a, 110b combine to divide the access opening 102, and thus the interior storage region 72, into first-third storage columns 120a-120c, with each of the columns 120a-120c sized to receive various ones of the totes 52 in stacked-like fashion. In other embodiments, more or less than three of the storage columns 120a-120c can be defined (e.g., by including more of less of the front intermediate uprights 112a, 112b) so long as each of the storage columns 120a-120c has the lateral spacing S at the access opening 102 sufficient to permit passage of respective ones of the totes 52.

With reference to FIG. 3D, the uprights 90 further include rear intermediate uprights 122 extending vertically upwardly from the base 60 at or adjacent the rear 94 of the interior storage region 72. The rear intermediate uprights 122 are aligned with, but laterally spaced from, the rear corner uprights 110c, 110d. In some constructions, the rear intermediate uprights 122 correspond, in terms of number and location, with the front intermediate uprights 112 (FIG. 3C). For example, with embodiments including the first and second rear intermediate uprights 112a, 112b, first and second rear intermediate uprights 122a, 122b are provided, with the first rear intermediate upright 122a transversely aligned with the first front intermediate upright 112a, and the second rear intermediate upright 122b transversely aligned with the second front intermediate upright 112b.

The uprights 90 further include secondary rear uprights 124 extending vertically upwardly from the base 60 at or adjacent the rear 94 of the interior storage region 72. The secondary rear uprights 124 are positioned between (and aligned with) adjacent ones of the rear corner uprights 110c, 110d and the rear intermediate uprights 122a, 122b. For example, a first secondary rear upright 124a is disposed between the fourth corner upright 110d and the first rear intermediate upright 122a. Second and third secondary rear uprights 124b, 124c are located as shown. The secondary rear uprights 124a-124c prevent passage of totes 52 (FIG. 2A) through the rear 94 of the interior storage region 72. For example, the first secondary rear upright 124a effectively divides the lateral spacing S between the fourth corner upright 110d and the first rear intermediate upright 122a into segments S₁, S₂. The first secondary rear upright 124a may or may not be equidistantly spaced between the corresponding fourth corner upright 110d and the first rear intermediate upright 122a. Regardless, a lateral dimension (i.e., in the horizontal plane) of each of the segments S₁, S₂ is less than a corresponding dimension of the totes 52 as described below, such that the first secondary rear upright 124a impedes passage of the totes 52 from the corresponding first column 120a via the back 94 of the interior storage region 72. That is to say, and with cross-reference between FIGS. 3C and 3D, where the fourth corner upright 110d is aligned with the first corner upright 110a and the first rear intermediate upright 122a is aligned with the first front intermediate upright 112a, an identical lateral spacing S is established between the upright pairs 110a/112a and 110d/122a, and is sufficiently-sized for passage of one of the totes 52. However, a tote that is inserted into the first column 120a of the interior storage region 72 via the front 92 (i.e., between the first corner upright 110a and the first front intermediate upright 112a) cannot be removed from the first column 120a of the internal storage region 72 via the rear 94 due to presence the first secondary rear upright 124a (i.e., the tote 52 cannot “fit” through either of the segments S₁, S₂). Similar relationships are established by the second secondary rear upright 124b relative to the second column 120b, and by the third secondary rear upright 124c relative to the third column 120c. In other embodiments, the secondary rear uprights 124 can be omitted, with the cart 50 instead including a separate door assembly (akin to the door assembly 66 (FIG. 2A) described below) that selectively blocks the lateral spacing S of each of the columns 120 at the rear 94 of the interior storage region 72.

A distance between the first and fourth corner uprights 110a, 110d and a distance between the second and third corner uprights 110b, 110c coincides with a corresponding dimension of the totes 52 (FIG. 2A) as described below such that in some embodiments, the framework 64 does not include intermediate uprights or secondary uprights at either of the first or second sides 96, 98. Instead, and as reflected in FIG. 3B relative to the first side 96, a longitudinal distance D between inner faces of the first and fourth corner uprights 110a, 110d can be less than a corresponding dimension (e.g., length) of the totes 52, such that the totes 52 cannot be removed from the interior storage region 72 via the first side 96. Further, and as described below, separate platform components can be provided that impede passage of totes 52 through the sides 96, 98. For example, while an overall length or depth of each of the columns 120 (i.e., the interior storage region length L₁ (FIG. 3A) described above) is slightly greater than a length of the totes 52, the longitudinal distance D between the inner faces of the corner uprights 110a, 110d and 110b, 110c otherwise defining the sides 96, 98 is less than the tote length such that the totes 52 cannot “fit” through the longitudinal distance D. Alternatively, however, depending upon a size of the cart 50 and/or dimensions of the totes 52, one or more intermediate uprights can be provided at one or both of the first and second sides 96, 98 of the interior storage region 72, sufficient to prevent passage of the totes 52 through the sides 96, 98.

In addition to the uprights 90 described above, the framework 64 includes a plurality of horizontally arranged platforms 130. The platforms 130 can assume various forms, and generally divide the interior storage region columns 120 into compartments C (two of which are labeled as C1 and C2 in FIG. 3C). A distance between vertically adjacent ones of the platforms 130, and thus a height H_{C} of each of the compartments C, corresponds with (e.g., is slightly greater than) dimensions (e.g., a height dimension) of the totes 52 (FIG. 2A) as described below. In some embodiments, each of the platforms 130 is formed by opposing, separated horizontal platform segments 132, 134 (as identified for a first one of the platforms 130a in FIG. 3C). The horizontal platform segments 132, 134 extend from opposing ones of the uprights 90 otherwise defining a particular column 120, and can be physically separated from one another as shown. For example, with respect to the first platform 130a in the first column 120a, the first horizontal platform segment 132 is attached to and extends from the first corner upright 110a, and the second horizontal platform segment 134 is attached to and extends from the first front intermediate upright 112a. Alternatively, the horizontal platform segments 132, 134 can be integrally formed, such that each platform 130 is a singular panel-like structure extending between the corresponding pair of uprights 90 (e.g., the first platform 130a can be a single panel extending between the first corner upright 110a and the first front intermediate upright 112a). Regardless, the platforms 130 associated with the second column 120b extends from and between the corresponding front intermediate uprights 112a, 112b, and the platforms 130 of the third column 120c extend between the second front intermediate upright 112b and the second corner upright 110b. As shown in FIG. 3B, the platforms 130 can extend to the rear 94 of the interior storage region 72 (e.g., with respect to the first platform 130a visible in FIGS. 3B-3D, the platform segments 132, 134 extend to the fourth corner upright 110d and the first rear intermediate upright 122a, respectively). In some constructions, the platforms 130 are aligned across the columns 120. Alternatively, a non-uniform arrangement of the platforms 130 can be employed. Regardless, the upper-most platform 130 associated with each of the columns 120 (e.g., the platforms 130b-130d labeled in FIG. 3C) is beneficially located within a predetermined distance from the top 100 of the interior storage region 72 as a function of a corresponding dimension of the totes 52 for reasons made clear below.

In addition to slidably supporting individual ones of the totes 52 (FIG. 2A), one or more of the platforms 130 can be configured to impede passage of totes through one of the sides 96, 98 of the interior storage region 72. For example, FIG. 3B reflects the first side 96 of the interior storage region 72. Each of the platforms 130 shown in FIG. 3B includes a horizontal platform body 136 and a vertical shoulder 138 (identified for the platform 130e in FIG. 3B). The horizontal platform body 136 is referenced generally in FIG. 3B and, as identified in FIG. 3C, can consist of the horizontal platform segments 132, 134 described above. The horizontal platform body 136 serves as the structure upon which an individual tote 52 is slidably supported, with the vertical shoulder 138 depending from the horizontal platform body 136. Alternatively, the vertical shoulder 138 can project upwardly from the horizontal platform body 136. Regardless, the vertical shoulder 138 serves to impede passage of a tote from the interior storage region 72 via the first side 96. In particular, a vertical spacing between vertically adjacent ones of the horizontal platform bodies 136 is slightly greater than a dimension (e.g., height) of the totes 52 such that a tote readily slides along a selected platform body 136. The vertical spacing between the vertical shoulder 138 and the platform body 136 of a vertically adjacent platform 130, however, is less than this same tote dimension such that the tote cannot pass through the first side 96 of the interior storage region 72 (i.e., a tote cannot “fit” between the horizontal platform body 136 and the vertical shoulder 138 immediately above the platform body 136).

As a point of reference, each of the compartments C generated in part by respective ones of the platforms 130 is sized and shaped to receive, in some embodiments, a single one of the totes 52 (FIG. 2A). With constructions in which the framework 64 divides the interior storage region 72 into the columns 120, each column 120 includes a series of vertically aligned ones of the compartments C. The but one acceptable framework construction of FIGS. 3A-3D configures the compartments C to have a length L_{C} (FIGS. 3A and 3B) and a width W_{C} (FIGS. 3C and 3D), as well as the height H_{C} (FIGS. 3C and 3D) described above. A direction of the compartment width W_{C} corresponds with a direction of the interior storage region length L₁ so as to provide rows of three compartments C across the interior storage region length L₁ (it being understood that the compartment width W_{C} is identical to the lateral spacing S between adjacent ones of the front uprights 110a/112a, 112a/112b, and 112b/110b). Conversely, a direction of the compartment length L_{C} corresponds with a direction of the interior storage region width W_{I}, with respective ones of the compartments C extending across the interior storage region width W_{I}. As described below, the compartment dimensions L_{C}, W_{C}, H_{C} are selected in accordance with dimensions of the totes 52.

As best shown in FIG. 3A, in addition to the uprights 90 and the platforms 130, the framework 64 can further include perimeter top bars 140a-140d interconnecting the corner uprights 110a-110d at the top 100 of the interior storage region 72. Inner edges 142 associated with each of the bars 140a-140d combine to define a perimeter of a passage 144 (referenced generally) to the top 100 of the interior storage region 72. For reasons made clear below, the inner edges 142 are located inwardly of the corresponding corner uprights 110a-110d. For example, and as evidenced by a comparison of FIG. 3A with FIG. 3E (otherwise illustrating a top view of the base 60 and the framework 64 with the top bars 140a-140d removed), a distance between the inner edges 142 of the first and third top bars 140a, 140c is less than a distance between the first and fourth corner uprights 110a, 110d. Further, and with specific reference to FIG. 3A, the framework 64 can include one or more cross beams 146 extending between the first and third perimeter top bars 140a, 140c, and aligned with corresponding pairs of the front and rear intermediate uprights 112, 122, as well as the secondary rear uprights 124. For example, a first cross beam 146a is aligned with the first secondary rear upright 124a, a second cross beam 146b is aligned with the first front and rear intermediate uprights 112a, 122a, etc. The cross beams 146 effectively divide the passage 144 into a plurality of the secondary openings 104, with each secondary opening 104 having dimensions less than corresponding dimensions of the totes 52 (FIG. 2A) such that the totes 52 cannot be removed from the interior storage region 72 via the top 100.

With continued reference to FIGS. 3A-3E, the framework 64 has been described as consisting of a series of discretely spaced bars, beams or rails combining to generate a generally open, cage-like construction. To provide requisite support, components of the framework 64 are formed of rigid, strong materials, such as steel. Alternatively, the framework 64 can be constructed to define one or more of the rear, side, and/or top 94-100 of the interior storage region 72 with a continuous wall (e.g., the rear 94 can be entirely closed). In addition, one or more partial walls or closures can be provided. For example, FIG. 2A illustrates a panel 150 adjacent the first side 96 (referenced generally) of the interior storage region 72. The panel 150 generally encompasses a space between the opposing corner uprights 110a, 110d, and in some constructions is configured to receive a plastic panel, paper label, or other structure (e.g., RFID tag) that identifies pharmaceutical items of the loaded cart assembly 30 (and/or a retail seller that will receive the loaded cart assembly 30). In other embodiments, the panel 150 can be omitted.

1 The door assembly 66 includes, in some constructions, first and second doors 200a, 200b that are pivotably mounted to the framework 64. The doors 200a, 200b are shown in greater detail in FIGS. 4A and 4B (with FIG. 4A illustrating the doors 200a, 200b apart from the framework 64, and FIG. 4B illustrating the cart 50 upon final assembly and with the doors 200a, 200b in the closed position). The doors 200a, 200b can be identical, such that the following description of the first door 200a applies equally to the second door 200b. The door 200a can have a generally frame-like (or open) construction, and includes opposing first and second side rails 202a, 202b, opposing first and second end rails 204a, 204b, and one or more intermediate vertical rails 206. The rails 202-206 are metal rods or beams, and are arranged as a function of the configuration of the access opening 102 defined by the framework 64, with one or more of the various door rails 202-206 positioned to at least partially block access to the interior storage region 72 via the access opening 102 when the door 200a is in the closed position. As a point of reference, the door 200a is generally configured for assembly to the framework 64 via a hinged coupling between the first side rail 202a and the first corner upright 110a in some embodiments. A height of the door 200a (i.e., linear distance between the end rails 204a, 204b) is slightly less than a height of the framework 64 such that when the first side rail 202a is coupled to the first corner upright 110a, the first end rail 204a is proximate the top 100, and the second end rail 204b is proximate the base 60. A width of the door 200a (i.e., linear distance between the side rails 202a, 202b) is such that with the first side rail 202a coupled to the first corner upright 110a and the door 200a in the closed position, the second side rail 202a extends within the lateral spacing S between the front intermediate uprights 112a, 112b. The so-positioned second side rail 202b thus serves to “block” the access opening 102 along the second column 120b. More particularly, in the closed position, the second side rail 202b spatially divides the lateral spacing S of the second column 120b (at the access opening 102) into segments S₃, S₄ each having a lateral dimension less than a corresponding dimension of the totes 52 (FIG. 2A), thereby preventing removal of the totes 52 from the second column 120b via the access opening 102. Stated otherwise, while the lateral spacing S is sufficient to permit passage of individual totes 52 into the second column 120b (e.g., the lateral spacing S is slightly greater than a width of each of the totes 52), the segments S₃, S₄ are less than this same tote dimension (e.g., the linear distance or size of the segments S₃, S₄ are less than the tote width) such that the totes 52 in the second column 120b cannot “fit” between the first front intermediate upright 112a and the second side rail 202b, or between the second side rail 202b and the second front intermediate upright 112b.

The intermediate vertical rail 206 is located relative to the first side rail 202a such that with the first side rail 202a coupled to the first corner upright 110a and the door 200a in the closed position, the intermediate vertical rail 206 extends within the lateral spacing S between the first corner upright 110a and the first front intermediate upright 112a. Thus, the intermediate vertical rail 206 “blocks” the access opening 102 at the first column 120a. In the closed position, the lateral distance between the first corner upright 110a and the intermediate vertical rail 206, and between the intermediate vertical rail 206 and the first intermediate upright 112a, is less than a corresponding dimension of the totes 52 (FIG. 2A). Stated otherwise, a width of each of the totes 52 permits sliding insertion/removal between the first corner upright 110a and the first front intermediate upright 112a (with the door 200a in the open position), but (with the door 200a in the closed position) will not “fit” between the first corner upright 110a and the intermediate vertical rail 206, or between the vertical rail 206 and the first front intermediate upright 112a.

The spacing between the side rails 202a, 202b and the intermediate vertical rail 206 establishes one or more windows 208 in the door 200a. In the closed position, then, the interior storage region 72 (and thus any of the totes 52 (FIG. 2A) contained therein) is viewable through the windows 208. However, the door rails 202-206 prevent removal of the contained totes 52 as described above.

A similar relationship is achieved with the second door 200b relative to the front side access opening 102 at the second and third columns 120b, 120c. The doors 200a, 200b can be hingedly connected to the first and second corner uprights 110a, 110b, or any other portion of the framework 64. Alternatively, the doors 200a, 200b can be slidably associated with the framework 64. In yet other embodiments, the door assembly 66 consists of a single door. Further, while the doors 200a, 200b have been described as having an open, frame-like construction, in other embodiments, one or both of the doors 200a, 200b can be solid walls.

Returning to FIG. 2A, the locking mechanism 68 can assume various forms appropriate for selectively locking the door assembly 66 (for example the first and second doors 200a, 200b) relative to the framework 64 in a tamper evident manner. In some embodiments, a separate one of the locking mechanisms 68 is provided for each of the doors 200a, 200b (e.g., a first locking mechanism 68a is provided for the first door 200a, and a second locking mechanism 68b is provided for the second door 200b). The locking mechanisms 68a, 68b can be identical, with FIG. 5 illustrating one embodiment of the locking mechanism 68 in simplified form (and relative to the first door 200a). The locking mechanism 68 includes a guide block 220, a latch pin 222, and a safety seal 224. The guide block 220 is mounted to the framework 64 (e.g., the first front intermediate upright 112a as shown), and forms a bore (hidden in FIG. 5) sized to slidably receive the pin 222. The guide block 220 is located such that when the first door 200a is in the closed position of FIG. 5, a bottom edge 226 of the guide block 220 is directly above a cross rail 228 provided with the door 200a.

The pin 222 has a length defined between opposing, first and second ends 230, 232 sufficient to extend through the guide block 220 and interface with the cross rail 228. For example, the cross rail 228 includes a lip 234 forming a hole (hidden). In the closed position of FIG. 5, the guide block bore (hidden) is aligned with the cross rail hole; the pin 222 is inserted through the guide block 220 and the lip 234 such that the first end 230 is above the guide block 220 and the second end 232 is below the cross rail lip 234. In this inserted position, the pin 222 prevents the door 200a from moving/opening relative to the framework 64.

The first end 230 of the pin 222 can be enlarged (relative to a size of the guide block bore (hidden)) to prevent the pin 222 from falling through the guide block 220. Further, to prevent accidental loss of the pin 222, a wire tether 236 can be connected at one end to the pin 222 and permanently secured at an opposite end to the door 200a or the framework 64. In this way, even when the pin 222 is removed from the guide block 220, it remains with the door 200a for later use.

The safety seal 224 provides security or tamper evidence to the locking mechanism 68 and can assume various forms. In some embodiments, the safety seal 224 is a zip tie-type device having a strap 238 and a base 240, and carrying a coded label 242. As with conventional zip ties, the strap 238 is inserted through the base 240 and can be pulled or tightened in only a single direction. The coded label 242 is permanently affixed to the base 240 and displays a unique code (e.g., numbers, letters, alphanumeric, etc.). With this construction, the strap 238 is wrapped around the first front intermediate upright 112a and the cross rail 228, inserted into the base 240, and then tightened. Once the strap 238 is tightened, the door 200a is held tightly against the framework 64 and the door 200a can only be opened by cutting the strap 236. Thus, even if the pin 222 were withdrawn from the guide block 220, the door 200a cannot be opened without destroying the safety seal 224; further, by tightly securing the door 200a against the framework 64, a person's fingers/hands cannot reach between the door 200a and the framework 64 in a manner permitting opening of the totes 52 (FIG. 2A).

The locking mechanism 68 can assume a variety of other forms providing secured, tamper evident closure of the door 200a. For example, the safety seal 224 can be secured through the pin 222. As a point of reference, additional guide blocks 220a, 220b can be provided along the first side 96 and the second side 98, respectively, of the framework 64 as shown in FIG. 3C and employed to hold the corresponding door 200a, 200b in the open position (via insertion of the corresponding pin 222).

Returning to FIG. 2A, the optional wheel guard 70 can have various forms, and is generally configured to protect a user's feet from inadvertently contacting one of the wheels 62. Alternatively, the wheel guards 70 can be omitted.

Finally, and as best shown in FIG. 2B, the optional table 71 is slidably maintained by the framework 64, and is generally sized and shaped to support individual ones of the totes 52 in an extended position relative to the framework 64. In the extended position of in FIG. 2B, the table 71 projects from or beyond the front 92 (referenced generally) of the interior storage region 72. For example, the framework 64 can include a bracket assembly 240 (referenced generally) maintaining a series of rollers (not shown) or other mechanisms facilitating sliding movement of the table 71 as well as cantilevered support to the table 71 in the extended position sufficient to offset forces of a relatively heavy tote placed on the table 71. In the retracted position of FIG. 2A, the table 71 (hidden in FIG. 2A) is withdrawn into the framework 64 in a manner that does not impede arrangement of the door assembly 66 to the closed position (i.e., when fully retracted, the table 71 does not prevent pivoting of the doors 200a, 200b to the closed position and locking thereof with the locking mechanism 68). In other embodiments, the table 71 can be omitted.

In some embodiments, the totes 52 are identical, with each tote 52 being sized in accordance with dimensions associated with the individual compartments C (FIG. 3C) formed by the cart 50 (or vice-versa). In one embodiment, and as best shown in FIG. 6, each of the totes 52 includes a bin 250 and two (or more) container assemblies 252. In general terms, the container assemblies 252 are retained within the bin 250, with the bin 250, in turn, defining an overall footprint of the tote 52.

The bin 250 can assume various forms and in some embodiments is, or is akin to, the plastic bins or totes conventionally utilized by pharmaceutical warehouses when shipping or distributing pharmaceuticals to retail sellers. The bin 250 has or defines a housing 260 and one or more cover segments 262. The housing 260 defines an internal volume 264 within which the container assemblies 252 are received. The cover segments 262 are pivotably coupled to the housing 260 and can be transitioned or moved between a closed state and an open state relative to the housing 260. In the closed state, the cover segments 262 cover the internal volume 264. Conversely, in the open state of the cover segments 262, the internal volume 264 (and thus the container assemblies 252 and any pharmaceutical items (not shown) contained therein) can be accessed. While the cover segments 262 can alternatively be removably coupled to the housing 260 in other manners (e.g., snap fit, sliding, etc.), the optional hinged arrangement combines with features of the cart 50 (FIG. 2A) to provide security benefits as described below.

The container assemblies 252 are, in some constructions, identical. The container assemblies 252 each include a container 270 and one or more dividers 272. The container 270 is sized and shaped in accordance with dimensions of the bin 250 such that in some embodiments, two of the containers 270 closely nest within the bin internal volume 264 in a side-by-side arrangement. One of the containers 270 is shown in greater detail in FIGS. 7A-7C, and generally includes a bottom wall 280, opposing side walls 282a, 282b, and opposing end walls 284a, 284b. The walls 280-284b combine to define a containment region 286 within which packaged pharmaceutical items (not shown), such as various, differently-sized packaged pharmaceutical items, can be temporarily stored. The containment region 286 is open at an upper edge 288 of the side walls and end walls 282a-284b. In some constructions, the side walls 282a, 282b and the end walls 284a, 284b project slightly outwardly in extension from the bottom wall 280 to the upper edge 288, such that a perimeter or size of the container 270 increases from the bottom wall 280 to the upper edge 288. Regardless, the container 270 incorporates features configured to selectively receive individual ones of the dividers 272.

In particular, a plurality of spaced apart divider ribs 290 are formed along an internal face 292 of each of the side walls 282a, 282b (the divider ribs 290 of the first side wall 282a being visible in the views). For example, the divider ribs 290 can include a lower set of rib segments 294a located adjacent the bottom wall 280 and an upper set of rib segments 294b adjacent the upper edge 288. In other constructions, the ribs 290 are continuous along a height of the internal surface 292. Regardless, adjacent ones of the divider ribs 290 are laterally spaced from one another to define a plurality of slots 296. A width of the slots 296 corresponds with (e.g., slightly greater than) a thickness of the divider 272 (FIG. 6) such that the divider 272 can be slidably received within respective ones of the slots 296. Though hidden in the views, similar divider ribs are provided along the internal face of the second side wall 282b, with the resultant slots defined along the second side wall 282b being aligned with corresponding ones of the slots 296 defined along the first side wall 282a.

In addition to the divider ribs 290, one or more stacking shoulders 298 can be formed along the internal face 292 of one or both of the side walls 282a, 282b. In general terms, the stacking shoulder 298 promotes nested stacking of one of the containers 270 within a second one of the containers 270. For example, FIG. 8 illustrates first and second containers 270a, 270b. Stacking of the containers 270a, 270b generally entails inserting the first container 270a into the containment region 286 of the second container 270b until the bottom wall 280 of the first container 270a nests on the stacking shoulder(s) 298 of the second container 270b. By impeding complete insertion of the first container 270a into the second container 270b, the stacking shoulder(s) 298 prevent the first container 270a from becoming frictionally “locked” to the second container 270b. In other embodiments, the stacking shoulder(s) 298 can be omitted.

Returning to FIGS. 7A-7C, to promote insertion and removal of the containers 270 relative to the internal volume 264 (FIG. 6) of the bin 250 (FIG. 6), thumb holes 300 can be formed in one or both of the end walls 284a, 284b. In other embodiments, the thumb holes 300 can be omitted. The container 270 can also incorporate additional features for stacking within the bin 250. For example, one or more feet 302 can extend from the bottom wall 280 as shown in FIG. 7B, and promote arrangement of the container 270 at a desired height within the bin 250,

The container 270 can have a variety of different dimensions. In some constructions, however, a length and width at the upper edge 288 defines a maximum footprint of the container 270. With reference to FIG. 7C, in some embodiments, the upper edge 288 defines a container maximum length L_{R} in the range 8-11 inches, alternatively approximately 9.7 inches, and a container maximum width W_{R} in the range of 7-10 inches, alternatively approximately 8.6 inches. Other dimensions are also envisioned. In some constructions, the container maximum length L_{R} and the width W_{R} dimensions are selected as a function of a size of the bin 250 (FIG. 6), and in particular to conveniently nest two of the containers 270 side-by-side within the bin internal volume 264 (i.e., the dimensions of the bin 250 are predetermined and the containers 270 are sized and shaped as a function of these predetermined dimensions). Conversely, the container maximum length L_{R} and width W_{R} dimensions can be predetermined and the bin 250 sized and shaped as a function of these predetermined dimensions.

Returning to FIG. 6, the dividers 272 are generally sized and shaped in accordance with a size and shape of the container 270, and in particular as a function of the slots 296 and a linear distance between the side walls 282a, 282b. For example, and with additional reference to FIGS. 9A and 9B, the divider 272 can be a plate-like body having a thickness approximating a width of the container slots 296 (FIG. 7A). The divider 272 defines a bottom edge 320, a top edge 322, a first side edge 324, and a second side edge 326. The bottom edge 320 has a length (i.e., distance between the side edges 324, 326 at the bottom edge 320) approximating a width of the container 270 at the bottom wall 280 (e.g., linear distance between the side walls 282a, 282b). Similarly, the top edge 322 has a linear length approximating a distance between the side walls 282a, 282b at the upper edge 288. As shown, a length L_{D} of the divider 272 tapers from the top edge 322 to the bottom edge 320, approximating a taper defined by the container side walls 282a, 282b. The top edge 322 can have a curved shape in extension between the side edges 324, 326 as shown. For example, a central region 328 having a concave curvature can be defined. In other embodiments, however, the top edge 322 can be straight, have a convex curvature, etc.

While the divider 272 is generally configured to extend across and between the opposing container side walls 282a, 282b, additional features can be incorporated to promote ease of insertion and removal of the divider 272 relative to the container 270. For example, and as best shown in FIG. 9B, the first side edge 324 can include or define one or more bumps 330. The bump(s) 330 is generally defined as a projection from a major plane of the first side edge 324 in a direction opposite the second side edge 326, and serves as the primary surface(s) of the divider 272 otherwise directly bearing against the corresponding container side wall 282a or 282b upon assembly of the divider 272 to the container 270. By providing a relatively small area of frictional contact (as opposed to frictional contact along an entirety of the first side edge 324), the bump(s) 330 minimizes occurrences of frictional “locking” between the divider 272 and the container 270 in a manner that might otherwise render it difficult for a user to remove (or insert) the divider 272. While two of the bumps 330 are illustrated, any other number, either greater or lesser, is also acceptable. In yet other embodiments, the bump(s) 330 can be additionally formed on the second side edge 326. Conversely, the bump(s) 330 can be omitted.

With the above construction, the container assemblies 252 are conveniently configured to contain a plurality of differently sized, packaged pharmaceutical items in an organized fashion. For example, one or more of the dividers 272 can be selectively assembled to the corresponding container 270 so as to divide the container containment region 286 into discrete zones that are sized in accordance with the packaged pharmaceutical items disposed therein. For example, FIG. 10 generally illustrates, in simplified form, one embodiment of the tote 52 loaded with packaged pharmaceutical items 350 (referenced generally). In particular, two of the container assemblies 252a, 252b are nested within the bin 250 (the cover segments 262 (FIG. 6) of the bin 250 are omitted from the view of FIG. 10 for ease of illustration). The container 270a of the first container assembly 252a contains three different packaged pharmaceutical item formats 350a-350c, with the corresponding dividers 272a, 272b being assembled to the container 270a in a manner dividing the containment region 286a into three zones 352a-352c each sized in accordance with the corresponding selected packaged pharmaceutical items 350a-350c (e.g., a selected distance of the first divider 272a from the first end wall 284a of the first container 270a corresponds with a dimension of the first package pharmaceutical item format 350a, etc.). The container 270b of the second container assembly 252b contains two additional pharmaceutical item formats 350d, 350e, with the corresponding divider 272c arranged to divide the containment region 286b into two zones 352d, 352e corresponding with sizes of the selected packaged pharmaceutical item formats 350d, 350e. The container assemblies 252a, 252b can be arranged in a plethora of other configurations (via location of the corresponding divider(s) 272) pursuant to the selected packaged pharmaceutical item format 350. For example, the user can estimate a desired size of the necessary containment region zones, and then assemble the divider(s) 272 to the container 270 in accordance with this estimation. Alternatively, a user can, prior to placement of any of the dividers 272 within the container 270, load a desired quantity of a first pharmaceutical item format into the container 270 and then place one of the dividers 272 in close proximity to the so-arranged pharmaceutical items. A desired quantity of the second packaged pharmaceutical item format can then be loaded into the remaining open space of the containment region 286, followed by assembly of a second one of the dividers 272 (if necessary). The process is repeated until the container 270 is adequately “filled” with packaged pharmaceutical items. With this approach, the pharmaceutical items 350 are sorted within the bin 250.

Regardless of how a user decides to arrange the pharmaceutical items 350 within each of the container assemblies 252a, 252b, the bin 250 is then closed to fully encompass the loaded pharmaceutical items 350. For example, as shown in FIGS. 11A and 11B, the cover segments 262 are transitioned to a closed position relative to the housing 260, with the resultant tote 52 having maximum length L_{T}, width W_{T}, and height H_{T} dimensions as defined by the bin 250. As mentioned above, the tote dimensions L_{T}, W_{T}, H_{T} can be dictated by dimensions of the containers 270 (FIG. 7A); in other embodiments, the tote dimensions L_{T}, W_{T}, H_{T} dictate dimensions of the containers 270. Regardless, the tote dimensions L_{T}, W_{T}, H_{T} correspond with dimensions of the compartments C of the cart 50 (and vice-versa) as illustrated by FIGS. 12A and 12B. FIG. 12A is an enlarged front view of a portion of the cart system 30, illustrating a single tote 52 loaded within one of the compartments C defined between the first and second front intermediate uprights 112a, 112b and opposing platforms 130f, 130g. The doors 200a, 200b (FIG. 4B) are omitted from the view of FIG. 12A, and the second secondary rear upright 124b is visible. FIG. 12B is a top view of the arrangement of FIG. 12A from a cross-sectional plane immediately above the tote 52, and depicts portions the doors 200a, 200b. As shown, the compartment length L_{C} is slightly greater than the tote length

L_{T}; the compartment width W_{C} is slightly greater than the tote width W_{T}; and the compartment height H_{C} is slightly greater than the tote height H_{T}. With this dimensional correlation, the tote 52 can easily slide into, and be removed from, a corresponding one of the compartments C. In the shipping state of FIG. 12B, however, the dimensional correlation between the tote 52 and the compartment C is such that when the tote 52 is maneuvered at, or nearly at, the rear 94 of the interior storage region 72 (e.g., in contact with the second secondary rear upright 124b), the tote 52 is entirely “behind” the front 92 of the interior storage region 72. Stated otherwise, in the shipping state, the tote 52 does not project beyond a plane defined by the corner uprights 110a, 110d (FIG. 3C), and the front intermediate uprights 112a, 112b otherwise forming the front 92 of the interior storage region 72. Thus, the loaded tote 52 will not interfere with desired movement of the doors 200a, 200b to the closed position described above (i.e., abutting the front uprights 110a, 110b, 112a, 112b).

The cart system 30 is shown in FIG. 2A in the shipping state, with the totes 52 loaded within each of the compartments C (referenced generally). The door assembly 66 is in the closed position, and the locking mechanism 68 arranged to lock the door assembly 66 to the framework 64. In the shipping state, then, the totes 52 are secured within the cart 50. An optional informational tag 380 can be applied to, or carried by, one or more of the totes 52 and is exteriorly visible through the window 208 provided with one of the doors 200a, 200b (and through the front side access opening 102 of the framework 64). The totes 52 can further be visually seen through the various secondary openings 104. However, in the shipping state (with the locking mechanism 68 secured), the totes 52 cannot be manually removed from the cart 50 without evidence of tampering. Stated otherwise, unless one or more of the framework 64 members and/or the locking mechanism 68 is physically destroyed, the totes 52 are locked within the cart 50, thereby providing tamper evident security.

In some embodiments, the shipping state of the cart system 30 further ensures that the individual pharmaceutical items remain secured within the respective totes 52. For example, FIGS. 13A-13C illustrate a portion of the cart system 30, including the cart 50 loaded with three of the totes 52a-52c. As described above, the totes 52a-52c each includes the outer bin 250 having the cover segments 262. The cart 50 (in the shipping state) prevents removal of the totes 52a-52c. For example, the intermediate vertical rail 206 of the door 200a prevents removal of the totes 52a-52c through the front 92 of the interior storage region 72 (best shown in FIG. 13A). The first secondary rear upright 124a prevents removal of the totes 52a-52c through the rear 94 of the interior storage region 72 (best shown in FIG. 13B). As best shown in FIG. 13C, the first and fourth corner uprights 110a, 110d and/or the platform vertical shoulders 138 prevent removal of the totes 52a-52c through the first side 96 of the interior storage region 72 (though not shown, removal through the second side 98 of the interior storage region 72 is similarly prevented).

In addition, the cart 50 is configured to prevent opening of the cover segments 262 of any particular one of the bins 250, such that even though the cart framework 64 has a general “open” construction, the pharmaceutical items cannot be removed by a person “reaching through” the framework 64. That is to say, while it may be possible to physically touch one or more of the bins 250 through the secondary openings 104 (referenced generally) of the framework 64 and/or through the window 208 of the doors 200a, 200b, the cover segments 262 cannot be opened. For example, as best reflected in FIGS. 13A and 13B, the closely stacked arrangement of the second tote 52b directly above the first tote 52a prevents the cover segments 262 of the first tote 52a from being pivoted open. Further, the platform segments 132, 134 associated with the open compartment C1 directly above the compartment C2 within which the second tote 52b is loaded prevents the cover segments 262 of the second tote 52b from being pivoted open. Thus, even if the compartment C directly “above” a particular tote 52 is open, the pharmaceutical item contents of the tote 52 are securely maintained by the cart 50. Finally, with respect to the third tote 52c otherwise loaded into one of the uppermost compartments C3, the framework 64 prevents pivoting/opening of the corresponding cover segments 262. More particularly, and with reference to FIGS. 13C and 13D, the framework 64 is configured such that the tote 52c is completely disposed within the compartment C3. While the secondary opening 104 at the top 100 of the interior storage region 72 may render portions of the third tote 52c exteriorly accessible, the top perimeter bars 140 are arranged as a function of the dimensions of the bin 250 (or vice-versa) so as to prevent pivoted opening of the cover segments 262.

Returning to FIG. 2A, the cart system 30, in the shipping state, can be shipped from the primary distributor to the intended retail seller in various manners. In general terms, the cart system 30 is rolled onto a truck, delivered to the intended retail seller, and rolled off of the truck. Upon receipt, the retail seller can quickly review the pharmaceutical items carried by the cart system 30 by, for example, scanning a bar code or other informational device (e.g., RFID tag) carried by a label 400 secured to the cart 50 (e.g., at the panel 150). The locking mechanism 68 provides the retail seller with assurances that the intended pharmaceutical items have not been tampered with. The retail seller can then disengage the locking mechanism 68 and open the door assembly 66. In the open state of the cart system 30 shown in FIG. 14, then, individual ones of the totes 52 can be selectively removed from the corresponding compartments C, opened, and the pharmaceutical item contents 350 removed. Where the particular retail seller employs a shelving system to store pharmaceutical items, the cart 50 can be rolled along the shelving system as the totes 52 are removed and unloaded. The optional table 71 can be extended as desired, with individual ones of the totes 52 being placed on the table 71 while being unloaded.

Various methodologies can be employed by the primary distributor when loading one or more of the cart systems 30 for a particular retail seller. Some of the techniques envisioned by the present disclosure are described in U.S. Publication No. 2009/0192819 entitled “Pharmaceutical Distribution Systems and Methods,” the teachings of which are incorporated herein by reference. In general terms, a request for a plurality of different pharmaceutical items is placed by retail seller with the primary distributor. Shelving information indicative of a sequential arrangement of pharmaceutical items along a shelving system maintained by the retailer seller is reviewed. The cart system 30, otherwise having the plurality of compartments C within which individual ones of the bins 52 can be loaded, is provided, and a sequential order of the compartments C is designated. Based upon the retail seller's request, the retail seller's shelving information, and the designated sequential order of the compartments C, a compartment assignment plan is created that assigns the requested pharmaceutical items to respective compartments C in an order corresponding with the sequential arrangements of the retail seller's shelving system. Individual ones of the container assemblies 252 (FIG. 6) are then loaded with the requested pharmaceutical items from the primary distributor's inventory and placed in corresponding bins 250 (FIG. 6) in accordance with the compartment assignment plan. The so-loaded cart system 30 is delivered to the retail seller. The retail seller then unloads the pharmaceutical items directly from the cart system 30 to the retail seller's shelving system. Alternatively, the pharmaceutical items can be loaded to the various totes 52 in any other manner desired by the primary distributor and/or the secondary seller. In some embodiments, methods of the present disclosure include the primary distributor assigning three cart systems 30 to a particular retail seller for meeting the seller's needs on a consistent basis. At any point in time, one of the cart systems 30 is at the retail seller's site, a second one of the cart systems 30 is at the primary distributor's site, and the third cart system 30 is in transit between the primary distributor and the retail seller.

The cart systems and related methods of use of the present disclosure provide marked improvements over previous designs. The container assemblies (otherwise including a container configured to selectively receive one or more dividers at various spatial locations) affords the primary distributor the ability to arrange different pharmaceutical items formats in an organized fashion. The bins are sized to conveniently store two (or more) of the containers, with the cart constructions formatted in accordance with dimensions of the bins (or vice-versa). The cart, in turn, robustly stores a relatively large number of the loaded totes in an ordered, secured fashion whereby the totes and the contained pharmaceutical items cannot be removed from the cart without evidence of tampering. Finally, with the compartmental format of the cart, shelving information of a particular retail seller can optionally be correlated with an arrangement of the compartments to present pharmaceutical items to the retail seller in a manner promoting optimal unloading to the retail seller's shelves.

As compared to conventional pharmaceutical item primary distributor-to-retail seller distribution techniques in which palletized bins randomly loaded with pharmaceutical items are delivered to the retail seller, the cart systems of the present disclosure greatly reduce the labor and time spent receiving and replenishing product at the retail seller. For example, a time study comparison was performed to compare the average time spent by an experienced employee to unload and shelve received pharmaceutical items using conventional techniques with the cart system techniques of the present disclosure. For this time study, identically-sized bins were employed. It was found that the average time to unload a bin from the retail seller's receiving dock to its shelving system using the conventional technique was 3:43. In comparison, the average time to unload and store pharmaceutical items from the retail seller's receiving dock to its shelving system using the cart systems of the present disclosure was 1:19. This represents a time and labor savings of 2:24. This labor and time savings is highly significant, especially with mail order-type retail sellers, allowing mail order retail sellers to reallocate staff to other critical tasks.

Although the present disclosure has been described with reference to preferred embodiments, workers skilled in the art will recognize that changes can be made in form and detail without departing from the spirit and scope of the present disclosure.

What is claimed is:

1. A cart system for controlled distribution of pharmaceutical items from a primary distributor to a secondary seller of pharmaceuticals, the system comprising:
a cart including:
a base,
wheels connected to an underside of the base,
framework extending upwardly from the base, the framework forming an interior storage region having a front, a rear, a first side, and an opposing second side, wherein the framework defines an access opening to the front of the interior storage region,
a first door movably coupled to the framework to provide a closed position in which the first door extends over at least a portion of the access opening, and an open position in which the first door is displaced from the access opening, wherein the first door defines at least one window configured to permit viewing of the interior storage region through the window in the closed position,
a locking mechanism selectively locking the first door in the closed position; and
a plurality of totes removably disposed within the interior storage region and each configured to contain a plurality of differently sized pharmaceutical items;
wherein the system is configured to provide a shipping state in which the totes are loaded within the interior storage region, the door is locked in the closed position by the locking mechanism, a portion of each of the totes is visible from an exterior of the cart, and the totes cannot be removed from the interior storage region without evidence of tampering.

2. The system of claim 1, wherein the system is further configured to provide a load/unload state in which the locking mechanism is released, the first door is in the open position, and the totes are exteriorly removable from, and insertable into, the interior storage region via the access opening.

3. The system of claim 1, wherein the framework includes first and second vertical intermediate uprights laterally separated from one another by a lateral spacing defining at least a portion of the access opening, and further wherein the cart is configured such that in the closed position, a segment of the first door extends along the lateral spacing.

4. The system of claim 3, wherein each of the totes is sized in accordance with a dimension of the lateral spacing, including respective ones of the totes being slidable through the lateral spacing.

5. The system of claim 4, wherein a width of each of the totes is less than the lateral spacing.

6. The system of claim 5, wherein a length of each of the totes is greater than the lateral spacing.

7. The system of claim 5, wherein the first door is pivotably coupled to the framework and includes a first side rail, and further wherein the first door is arranged relative to the framework such that when the first door is pivoted to the closed position, the first side rail extends vertically between the first and second intermediate uprights, and further wherein the width of each of the totes is greater than a lateral spacing between the first intermediate upright and the first side rail, and a lateral spacing between the second intermediate upright and the first side rail in the closed position.

8. The system of claim 7, wherein the framework further includes a corner upright laterally spaced from the first intermediate upright at the front of the framework by a spacing greater than the width of each of the totes, and further wherein the first door includes an intermediate vertical rail arranged such that when the first door is pivoted to the closed position, the intermediate vertical rail extends vertically between the first intermediate upright and the corner upright.

9. The system of claim 1, wherein the cart further includes a second door movably coupled to the framework opposite the first door and providing a closed position in which the second door extends at least partially over the access opening and an open position in which the second door is displaced from the access opening.

10. The system of claim 9, wherein each of the first and second doors includes a first side rail and a second side rail, the first side rails being pivotably coupled to the framework, and the storage state including the second side rails being arranged immediately proximate one another.

11. The system of claim 9, wherein the framework defines the interior storage region to have first, second, and third columns each having a length dimension between the front and the back that is slightly greater than a length of each of the totes, and a width slightly greater than a width of each of the totes, and further wherein in the shipping state, the first door blocks a portion of the access opening in a region of the first and second columns, and the second door blocks a portion of the access opening in the region of the second and third columns.

12. The system of claim 1, wherein the framework further defines a top of the cart and includes at least one bar extending across the top and arranged to impede removal of the totes from the interior storage region via the top.

13. The system of claim 1, wherein the locking mechanism includes:
a retractable post assembled to one of the framework and the door; and
a receptacle assembled to an other of the framework and the door, the receptacle configured to selectively receive the post;
wherein the storage state includes the post being received within the receptacle.

14. The system of claim 1, wherein the cart further includes a table slidably assembled to the framework in a manner permitting selective extension of the table from the front for supporting one of the totes upon removal from the interior storage region.

15. The system of claim 1, wherein the framework includes a plurality of spaced uprights dividing the interior region into a plurality of columns each having a width greater than a width of each of the totes, and a plurality of horizontal platforms extending from the uprights for slidably supporting individual ones of the totes in respective ones of the columns.

16. The system of claim 1, wherein each of the totes includes printed indicia on an exterior surface thereof, and further wherein the storage state includes the printed indicia facing the front.

17. The system of claim 1, wherein each of the totes includes a first container assembly having a container and at least one divider, the container comprising a bottom wall, opposing first and second side walls, and opposing end walls combining to define an open containment region, and further wherein the divider is removably connectable with the opposing side walls to divide the containment region into at least two zones.

18. The system of claim 17, wherein an interior surface of each of the side walls forms a plurality of slots configured to slidably receive the divider, the slots of the first side wall being spatially aligned with the slots of the second side wall.

19. The system of claim 18, wherein the divider is configured to be assembled to the side walls at different longitudinal spacings relative to the end walls.

20. The system of claim 17, wherein the first container assembly further includes a second divider removably connectable to the opposing side walls.

21. The system of claim 17, wherein each of the totes further includes:
a second container assembly having a container and at least one divider, the containers of the first and second container assemblies being identical; and
a bin maintaining the first and second container assemblies in a side-by-side relationship.

22. The system of claim 21, wherein the first and second container assemblies are removable from the bin.

23. The system of claim 21, wherein the bin includes a cover configured to selectively cover the first and second container assemblies.

24. The system of claim 1, further comprising:
first and second pharmaceutical items contained within a first one of the totes;
wherein the first and second pharmaceutical items are different, and the first tote includes indicia on an exterior surface thereof identifying the first and second pharmaceutical items;
third and fourth pharmaceutical items contained within a second one of the totes;
wherein the third and fourth pharmaceutical items are different, and the second tote includes indicia on an exterior surface thereof identifying the third and fourth pharmaceutical items.

25. A system for controlled distribution of pharmaceutical items from a primary distributor to first and second secondary sellers of pharmaceuticals, the system comprising:
first and second cart systems each comprising:
a wheeled base maintaining framework forming an interior storage region divided into at least three columns each having a width and a length,
a door assembly pivotably coupled to the framework for selectively blocking an access opening to each of the columns,
a plurality of totes stored within respective ones of the columns, each of the totes having a length greater than a width, the length of each of the totes being slightly less than the length of the columns, and the width of each of the totes being slightly less than the width of each of the columns,
a plurality of pharmaceutical items contained within respective ones of the totes, wherein at least one of the pharmaceutical items in a first one of the totes differs in format from pharmaceutical items in an other of the totes,
wherein the cart systems are arranged in a shipping state in which the door assembly is locked in a closed position relative to the corresponding framework to prevent removal of the corresponding totes;
wherein pharmaceutical items of the first cart system are pre-selected for a first secondary seller, and the pharmaceutical items of the second cart system are pre-selected for a second secondary seller, the pharmaceutical items of the first cart system differing from the pharmaceutical items of the second cart system.

26. A method for distributing pharmaceutical items from a primary distributor to a secondary seller of pharmaceuticals, the method comprising:
maintaining an inventory of pharmaceutical items at the primary distributor;
receiving a request from the secondary seller to the primary distributor for a plurality of different pharmaceutical items;
retrieving a first set of the requested pharmaceutical items from the inventory of the primary distributor;
placing the retrieved first set of requested pharmaceutical items into a first tote;
retrieving a second set of the requested pharmaceutical items from the inventory of the primary distributor;
placing the second set of requested pharmaceutical items into a second tote;
loading the first and second totes into a cart including:
a base,
wheels connected to an underside of the base,
framework extending upwardly from the base, the framework forming an interior storage region having a front, a rear, and opposing sides, wherein the framework defines an access opening to the front of the interior storage region,
a door assembly coupled to the framework to provide a closed position in which the door assembly is extended over the access opening, and an open position in which the door assembly is displaced from the access opening, the door assembly defining at least one window configured to permit viewing of the interior storage region in the closed position,
wherein loading of the first and second totes into the cart includes disposing the first and second totes within the interior storage region;
locking the door assembly relative to the framework to form a cart system in a shipping state, the first and second totes being secured within, but exteriorly visible through, the framework and the door assembly; and
delivering the cart system in the shipping state to the secondary seller.

27. The method of claim 26, wherein the first set of requested pharmaceutical items are sorted within the first tote.

28. The method of claim 26, wherein the first tote includes a first container assembly including a container and a first divider, and further wherein the first set of requested pharmaceutical items includes a plurality of first pharmaceutical items and a plurality of second pharmaceutical items, the step of placing the first set of pharmaceutical items within the first tote including:
loading the first pharmaceutical items into a first zone of the container;
assembling the divider within the container to define a second zone discrete from the first zone; and
loading the second pharmaceutical items into the second zone.

29. The method of claim 28, wherein the first container assembly further includes a second divider, and the first set of pharmaceutical items includes a plurality of third pharmaceutical items, the step of placing the first set of pharmaceutical items into the first tote further including:
assembling the second divider within the container to define a third zone discrete from the first and second zones; and
loading the third pharmaceutical items into the third zone.

30. The method of claim 28, wherein the first tote further includes a second container assembly and a bin, and further wherein the first set of pharmaceutical items includes a plurality of third pharmaceutical items, the step of placing the first set of pharmaceutical items into the first tote further comprising:
loading the third pharmaceutical items into the second container assembly; and
placing the first and second container assemblies into the bin.
